(19) United States
(12) Patent Application Publication
(10) Pub. No.: US 2015/0332422 A1
(43) Pub. Date: Nov. 19, 2015

(54) Clearinghouse System for the Collection, Management and Identification of 340B Related Pharmaceutical Claims Under Various Medicaid and Medicaid Managed Care Programs

(71) Applicant: Edward Gilmartin, San Antonio, TX (US)

(72) Inventor: Edward Gilmartin, San Antonio, TX (US)

(21) Appl. No.: 14/713,426

(22) Filed: May 15, 2015

Related U.S. Application Data
(60) Provisional application No. 61/994,456, filed on May 16, 2014.
(60) Provisional application No. 62/018,206, filed on Jun. 27, 2014.

(51) Int. Cl. G06Q 50/22; G06Q 10/06

(52) U.S. Cl. CPC G06Q 50/22; G06Q 10/0631

(57) ABSTRACT

The present invention is directed to an exchange clearinghouse, to provide an improved method of processing all 340B Drug Pricing Program claims for all involved parties, to easily identify and report the 340B claims as well as overcome any challenges of the prior art without compromising security or accuracy. More particularly, the invention is a method that can alter, change, or reclassify previously adjudicated pharmacy claims (original claims) through a system, outside of and unrelated to the system used by the pharmacy service provider who adjudicated the original claim. This creates a reversing claim of the original claim and recreates an altered, changed or reclassified original claim. The Method also allows for the collection and reporting of accurate quantities of the original claim in which 340B priced drugs were used.

### PRIORITY CLAIM TO RELATED APPLICATION

This application claims the benefit of previously-filed U.S. Provisional Patent Application, Ser. No. 61/994,456, filed on May 16, 2014, entitled “Clearinghouse System for Processing Pharmaceutical Funding Claims Under Various Medicaid Programs”, as well as previously-filed U.S. Provisional Patent Application, Ser. No. 62/018,206, filed on Jun. 27, 2014, entitled “Clearinghouse System for Processing Pharmaceutical Funding Claims Under Various Medicaid Programs.” The entireties of those previously-filed applications are incorporated herein by this reference.

### BACKGROUND

1. Field of the Invention

The present invention relates generally to computerized systems for consolidated processing of Medicaid claims and, more particularly, to consolidated 340B Medicaid processing systems that are accessible to various user types through internet portals, by which data is collected, validated and managed as part of a pharmaceutical rebate program.

2. Description of Related Art

The United States Congress has tried time and again to help ensure affordable healthcare in the face of ever-increasing pharmaceutical costs, but the implications for healthcare providers are often confounding. In 1990, Congress created the Medicaid Drug Rebate Program to help offset the rising costs. The program effectively created a contractual relationship between pharmaceutical manufacturers and government agencies, particularly the Centers of Medicare and Medicaid Services (CMS) and state-run Medicaid Agencies, creating a rebate incentive aimed at helping offset the Federal and State expenses of most outpatient prescription drugs dispensed to Medicaid patients. The program required participating pharmaceutical manufacturers to provide rebates for certain medication purchases, in exchange for having their products covered by Medicaid. Nice idea, but it unexpectedly caused overall prices to drastically increase. Because the required rebate was based on each manufacturer's “best price”, the program nullified any incentive for manufacturers to reduce their prices in non-Medicaid markets, as doing so would lead to larger rebates in the Medicaid market. As a result, non-Medicaid patients were often charged higher rates than otherwise would have been charged prior to the Medicaid Drug Rebate Program.

Therefore, in 1992 the United States Federal Government created the 340B Drug Pricing Program, which required drug manufactures that currently participate in the 1990 Medicaid Drug Rebate program, to provide outpatient drugs to eligible healthcare organizations, safety net providers and covered entities at a significantly reduced price. Congress has stated that the primary goal of the 340B Drug Pricing Program was to allow covered entities to “stretch scarce federal recourses as far as possible, reaching more eligible patients and providing more comprehensive services.” The 340B discount is the same discount that manufacturers are required to provide to State Medicaid agencies. The intent was to maintain a high level of medical services while reducing medication costs for certain patients. The 340B Program has been amended and expanded multiple times since its enactment.

To participate in the 340B Program, eligible organizations such as covered entities, or Health Centers, must enroll and comply with all 340B Program requirements. Once enrolled, a covered entity is assigned a 340B identification number. The covered entity must then inform manufacturers and distributors that they wish to participate in the 340B Program when placing orders. Manufacturers and suppliers must verify that the health center is enrolled in the 340B program in order to sell outpatient drugs at the 340B discounted price. Thus, under the 340B Program, congress protects specific hospitals and clinics from drug price increases as well as giving those specific hospitals and clinics access to price reductions.

This program requires drug manufacturers to enter into and have in effect, a rebate agreement with the Secretary of the Department of Health and Human Services in exchange for state Medicaid coverage on most of the manufacturer's drugs. The manufacturers are responsible for paying a rebate for the covered outpatient drugs each time they are dispensed to Medicaid patients. These rebates are paid by drug manufacturers at predetermined intervals to the States and are shared between the State and the Federal Government to offset the overall cost of prescription drugs under the Medicaid program.

To date, there are approximately 600 different drug manufacturers currently participating in the 340B Drug Pricing Program. Further, all fifty states and the District of Columbia cover prescription drugs under the Medicaid Drug Rebate Program.

Despite the long history and wide spread industry use of the 340B Drug Pricing Program, the program still presents significant challenges for all parties involved. For example, while numerous medical providers rely on the program, it is difficult for those providers to effectively submit, process and manage claims under the 340B program.

A similar problem with the current system is that a significant amount of time, labor and effort is required for every pharmaceutical drug manufacturers or wholesalers to verify that each entity requesting the special 340B discounted rebate price has in fact been registered, approved, and enrolled in the 340B Drug Pricing Program.

Another problem with the current system is that each health center can have its own negotiated price with a manufacturer for a certain pharmaceutical drug. The listed 340B pharmaceutical drug price is the highest price that covered entity would have to pay a manufacturer for the drug, as the price is based on the Average Manufactures Price, less a discount that is equivalent to the states Medicaid drug program discounts. Health Centers can, negotiate prices with the manufacturers that are below the 340B Program drug price, thereby creating additional difficulty in processing the 340B Rebates as there is no singular price.

Additionally, drug manufacturers provide a discount to health centers and other covered entities when they purchase a drug. Health centers and other covered entities can use the discounted 340B drugs for all patients. However, since health centers must charge patients differently for the drugs, dependent on whether each individual patient qualifies to receive the drug at the discounted 340B price, thereby created an issue in verifying that drug manufacturers are repaid.

A similar problem with the current system is that health centers must keep track of which program is paying for the drugs in order to maintain compliance with the 340B rules. Drug manufacturers that participate in the Medicaid Drug Rebate Program must also participate in the 340B program. The discount amount is the same in the Medicaid Drug Rebate Program and the 340B Discount Program. However, while drug manufacturers participate in both programs, only one discount can be used. Specifically, either the state Medicaid agency receives a rebate price for the drugs provided to a Medicaid patient or the health center receives the 340B discounted price for its Medicaid patients.

As a result, there are numerous shortcomings, to both the patient and the provider, of the current system as utilized in the industry, which causes devastating financial implications, and therefore, as a consequence patient care could be compromised.

Many other problems, obstacles, limitations and challenges will be evident to those skilled in the art, particularly in light of the literature and experiences that are known in the industry. Therefore a need exists for systems and methods for identifying, tracking, and handling all aspects of the 340B discount program.

It would therefore be desirable to provide a system and method which could rapidly provide information for manufacturers, providers, patients, and government entities in order to consolidate the financial burden regarding the 340B prescription rebates as well as streamline communications between covered entities and pharmaceutical drug manufacturers or wholesalers. It is further desirable that health centers have a management information system that is able to handle and verify who should receive the 340B pricing and those who should not, as well as have the ability to track pricing for their drug sales to ensure the right prices are received.

### SUMMARY OF THE INVENTION

The present invention is directed to an exchange clearinghouse, to provide an improved method of processing all 340B Drug Pricing Program claims for all involved parties, to easily identify and report the 340B claims as well as overcome any challenges of the prior art without compromising security or accuracy.

The primary purpose of the present invention is to improve upon the prior art and enable better management of all aspects of processing and fulfilling 340B funded pharmaceutical supply chains. More particularly, the invention is a method that can alter, change, or reclassify previously adjudicated pharmacy claims (original claims) through a system, outside of and unrelated to the system used by the pharmacy service provider who adjudicated the original claim. This creates a reversing claim of the original claim and recreates an altered, changed or reclassified original claim. The Method also allows for the collection and reporting of accurate quantities of the original claim in which 340B priced drugs were used.

The Clearinghouse Method allows claims in which 340B drugs were used to reported accurately in ways in which the traditional National Council of Prescription Drug Programs (NCPDP) 340B “prior to service”, “point of service” or “post service” reporting methods cannot achieve. The embodiments of the invention are intended to facilitate 340B and related funded programs that incentivize healthcare providers to expand medication access to low-income individuals, families and other vulnerable populations.

In general, many embodiments of the invention provide a computer program product that utilizes a safe and secure environment for allowing providers, pharmacies, and 340B administrators to submit data files for identification directly relating to 340B claims. The present invention uses computers to complete the matching, altering, and modification of pharmacy claims at a speed and efficiency that cannot be achieved by hand based methods.

Such embodiments utilize an exchange clearinghouse that supports solutions for Managed Care Providers (“MCO”) to identify and report 340B claims to the proper administrators. Such a clearinghouse will administer data and shared savings arrangements with MCOs and participating 340B safety net providers, while also creating and supporting a simplified process for safety net providers, pharmacies and 340B administrators, allowing said parties to submit data files for the identification of 340B claims.

The system and method for processing pharmaceutical funding claims under the 340B Drug Pricing Program according to the present invention substantially departs from the conventional concepts and designs of the prior art, and in so doing provides a method that offers many advantages and novel features which are not anticipated, rendered obvious, or even suggested or implied by any of the prior art, either alone or in any obvious combination thereof. Many other objects, features and advantages of the present invention will become evident to the reader and it is intended that these objects, features and advantages are within the scope of the present invention.

While the benefits of the invention are more numerous than mentioned here, the use of such clearinghouse system creates a seamless solution for managed care providers to identify and report 340B claims. The resulting system allows for a singular streamlined system and other cost efficiencies while maintaining the rigid privacy and security requirements of HIPAA.

In this respect, before explaining at least one embodiment of the invention in detail, it is to be understood that the invention is not limited in its application to the details of the particular methods of collecting, processing and reporting certain types of data, nor to the particular arrangements of components set forth in the following descriptions or illustrated in the drawings. The invention is capable of many other embodiments and of being practiced and carried out in numerous other ways. Also, it is to be understood that the phraseology and terminology employed herein are for the purpose of the description and should not be regarded as limiting. While it should be recognized that this invention may be embodied in the form illustrated in the accompanying drawings, the description and drawings are illustrative only, and numerous changes may be made in the specifics illustrated or described.

### BRIEF DESCRIPTION OF THE DRAWINGS & EXHIBITS

The present invention will be more fully understood by reference to the accompanying drawings and exhibits, which are for illustrative, not limiting, purposes. The detailed description of some embodiments of the invention will be made below referencing to the accompanying figures.

FIG. 1 represents a diagram depicting the preferred embodiment of the Clearinghouse specifically detailing the directional flow of data, reports and cash through the system, as well as various 3rd party and governmental agencies that interact with the clearinghouse system.

FIG. 2 portrays an exemplary high level overview illustration of a clearinghouse system that facilitates the processing of claims under the 340B prescription rebate program, and embodies many aspects of the present invention.

FIGS. 3A and 3B together portray an exemplary a High Level Technical Architecture of the ETL process and a diagram illustrating an exemplary Data Flow Diagram of the claims processing system, respectively. Data containing claims under the 340B prescription rebate program, and other important internal information, is imported and extracted from multitude of origin sources, transformed within the system and output files and reports are created once the ETL is completed successfully.

FIG. 4 depicts a standard schematic during the ETL process of both master and child packages located in one environment that is stored in the SSIS catalog.

FIG. 5 illustrates an example overview of a system server architecture that facilitates the server performance and capabilities. The multiple SQL servers protect the data from corruption as the data is collected, validated, processed and managed as part of a pharmaceutical rebate program.

FIGS. 6A and 6B—Portray various aspects of the systems compliance with HIPAA regulations. FIG. 6A is an illustration of an embodiment of the preferred database encryption method. In addition to the security, the preferred embodiment also maintains a log depicting all errors that occurred during the data processing, as portrayed in FIG. 6B.

FIGS. 7A, 7B, and 7C—FIG. 7A depicts how one securely logs into the system to generate and send out miscellaneous reports. Specifically, FIG. 7A illustrates a block diagram of the SQL Reporting services (SSRS) as it generates reports for the system and how Reporting service requests are handled through the components of SSRS architecture. Similarly, FIG. 7B depicts the reporting services architecture in further technical detail including a three-tier system for securely requesting and accessing reports, generated by the system. FIG. 7C portrays the various SSIS configuration options the administrator can perform.

FIGS. 8A and 8B, together, provide a representation of data partitioning in efforts to maintain data integrity throughout the ETL and data processing. Specifically, FIG. 8A is a flowchart portraying how partitioning will distribute the data across multiple file groups, thereby preserving data integrity. FIG. 8B is an illustrative diagram of how the partitioning is designed to preserve data integrity while maintaining performance throughout the system.

FIGS. 9A, 9B, 9C, and 9D portrays an exemplary flowchart depicting how preferred embodiment processes information. Specifically, the flow chart Shows the importation, validation and processing of the clearinghouse system

FIGS. 10A and 10B illustrates an example of the “Entity” and “MCO” web portals, respectively, of a preferred embodiment. Each flow chart illustrates the preferred method that Entities; MCO's and their respective Administrators access, view and interact with the clearinghouse system, as it provides all Shared Savings Statements and Invoices in a user-friendly mode.

### DETAILED DESCRIPTION OF PREFERRED EMBODIMENT

With reference to the accompanying drawings, contemplated best modes and preferred embodiments of the invention will now be described in more detail. Although the description provides detailed examples of possible implementations of the present invention, it should be noted that these details are intended to be exemplary and in no way delimit the scope of the invention. The figures are not necessarily to scale or in a sequential order. Further, some features may be exaggerated or minimized to show details of particular components. In other instances, well-known materials or methods have not been described in detail to avoid obscuring the present invention. Therefore, specific structural and functional details disclosed herein are not to be interpreted as limiting, but as a basis for the claims and for teaching one skilled in the art to variously employ the present invention. Embodiments of the invention may include various systems, processes, methods, and apparatuses for the identification and reporting of 340B claims.

When used herein, the following terms, acronyms, definitions, and abbreviations take at least the meaning explicitly associated herein, unless the context dictates otherwise. The meanings identified below do not necessarily limit the terms, but merely provide illustrative examples of the terms. The abbreviation “MCO” refers to a Managed Care Organization(s). When a person decides to enroll in Family Care, that person becomes a member of a Managed Care Organization (MCO).

The term “Entity” refers to hospitals and clinics. Under HIPAA Privacy Rules, the term “Covered Entity” refers to three specific program groups including: healthcare plans, healthcare clearinghouses and healthcare providers that transmit health information electronically. The received data from Entities is imported into the system, processed, validated, and either approved or denied.

The abbreviation “WAC” stands for Wholesale Acquisition Cost. This is a published catalog which contains the manufacturers' list price for a drug product to wholesalers as reported to the First Databank. Another common abbreviation, “AWP” refers to Average Wholesale Price. This is a prescription drugs term referring to the average price at which drugs are purchased at the wholesale level. The AWP price is used to determine third-party reimbursement throughout the health care industry because third party payers have no other reliable method of obtaining real market prices. Both WAC and AWP are similar; however, individual State procedures vary, as each state uses one notation over the other. Therefore, the preferred embodiment utilizes both WAC and AWP standards in its clearinghouse dependent on each individual State procedure.

The term “clearinghouse” often refers to an organization that collects and processes information about numerous transactions. As used in these descriptions, the “clearinghouse” term refers to a computerized service or system that functions to electronically receive information about numerous claims, for further processing of that information to help users manage payments and/or credits for those claims. Hence, a 340B clearinghouse in this context is a computerized system or service that provides a common portal for electronically receiving data relevant to 340B claims and that systematically processes that data for the benefit of healthcare providers, practitioners, pharmacies, and MCO's. Reference to the “Claims Processing Solution” relates to the invention and its many embodiments as a whole, as it refers to the process that claims are processed through for the various medical providers, insurance companies, and patients.

The following computer variables and abbreviations have the following meaning unless otherwise indicated: “SQL” refers to a special purpose programming language known as Structured Query Language, designed for managing data held in a relational database management system. “SSIS” stands for the SQL Server Integration Services. The primary function for SSIS is data warehousing, as the product features a fast and flexible tool for data extraction, transformation, and loading (ETL). “ETL” refers to an Extract Transform and Load. “SSRS” refers to an SQL Reporting Services. “SMTP” refers to a Simple Mail Transfer Protocol. “API” refers to an Application Programming Interface. “SAN” refers to a Storage Area Network. “RAID” refers to a combination of multiple disk drive components that merge into a single logical unit of memory for the purposes of data redundancy and improved performance. “IO” refers to Input and Output of the system.

Where databases are described herein, it should be understood by one of ordinary skill in the art that alternative database structures to those described may be readily employed and other memory structures besides databases may be freely implemented. Further, it is readily apparent that the various methods and systems described herein may be implemented in part by appropriately programmed General Purpose Computing Devices. Typically a processor (e.g., a microprocessor) will receive instructions from a memory or like device, and execute those instructions, thereby performing a process defined by those instructions. Further, sets of instructions that implement such methods and algorithms may be stored as programs and transmitted using a variety of known media.

In general, the preferred embodiment is an internet based exchange clearinghouse to support solutions for MCO(s) and Entities to identify and report 340B claims. The applicants' HIPAA compliant clearinghouse provides a platform that collects MCO and approved claims transactions, provides data administration, shared savings processing, and compliance reporting services. In many best practice and hosting areas, this clearinghouse system leverages other claims processing systems, such as, most preferably, the applicant's Cumulus offering that is commercially available from applicant.

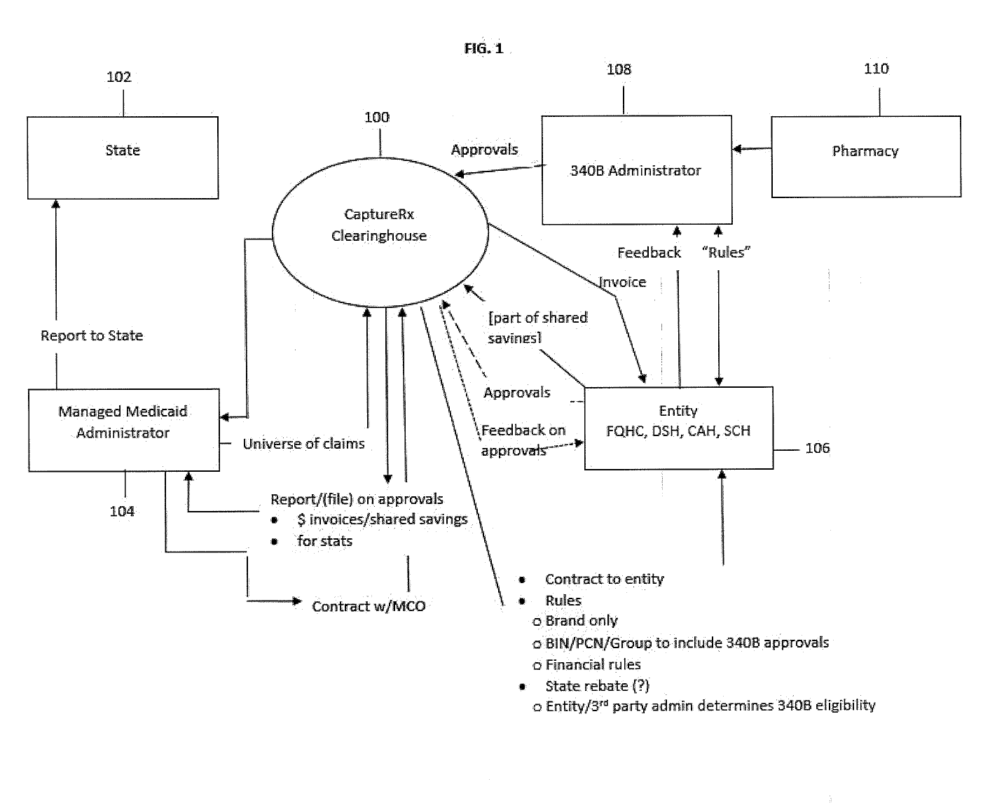

Reference is now made to FIG. 1 for a diagram depicting the preferred embodiment of the clearinghouse, in which it specifically details the directional flow information through the system. The focal point preferred embodiment as portrayed in FIG. 1, is the internal Clearinghouse system, 100, which monitors and manages the collection and dissemination of information. Specifically, in FIG. 1, the Clearinghouse system, 100, receives and exports information pertaining to miscellaneous data, various reports, and financial matters, as the information is distributed throughout the preferred embodiment.

The term “Data Flow”, as used in diagram as portrayed in FIG. 1, is a generic term used to explain various types of data being distributed through the system. Initially, the Data Flow, claims are imported to the clearinghouse, 100, from the Managed Medicaid Administrator, 104 and either Entities, 106 or their 340B administrators, 108. The Managed Medicaid Administrator, 104, distributes all of the 340B claims to the Clearinghouse, 100. The Clearinghouse, 100, collects claims, matches and/or processes them and then disseminates invoices to the various Entities, 106, that contract with and utilize the clearinghouse system. Entities, 106 as depicted in FIG. 1 refer to: Federally Qualified Health Centers, Disproportionate Share Hospitals, and the like. Further, Entities, 106, which contract to use the Clearinghouse system or their 340B administrators, 108, receive detailed feedback on claim matches from the Clearinghouse system, 100. Approved claims come to Clearinghouse system, 100 and system matches them to MCO data. In some embodiments, these Entities, 106, may forward the Feedback reports to the 340B Administrator, 108, in order to receive approval of the processed claims. Entities, 106, will receive approval from the 340B Administrator, 108, and forward the approved claims to the clearinghouse, 100, for the Clearinghouse to process. The feedback Report is discussed in further details below.

The lines demonstrating the directional flow of Reports, relate to both Reports and contractual relationships between parties. The Managed Medicaid Administrator, 104, is in a contractual relationship with the clearinghouse, 100. Similarly, various Entities, 106, are in a contractual relationship with the Managed Medicaid Administrator, 104. The 340B Administrator, 108, and the Entity, 106, are bound by certain rules which control the dataflow, 120, between them. The Clearinghouse, 100, exports a report to the Managed Medicaid Administrator, 104, detailing shared savings statements on matched records. Managed Medicaid Administrator, 104, gives a report to the State, 102, in which the claim originated.

The Final aspect FIG. 1 portrays is Cash Flow, 140. Pharmacies, 110, pay either Entities, 110, or the 340B Administrator, 108. If the Pharmacies, 110, pay the 340B Administrator, 108 then the 340B Administrator, 108, pass the rebate or plan savings directly onto the Entity, 106. Upon completion of processing the Shared Savings Statements, the Clearinghouses, 100, forwards the Shared Savings Statements to the Managed Medicaid Administrator, 104. Clearinghouse, 100, issues invoices to the entities 106 for the amount owed to Managed Medicaid Administrator, 104. Entities 106 transfer those funds to Trust account which are in turn sent to Managed Medicaid Administrator, 104 on an agreed upon frequency.

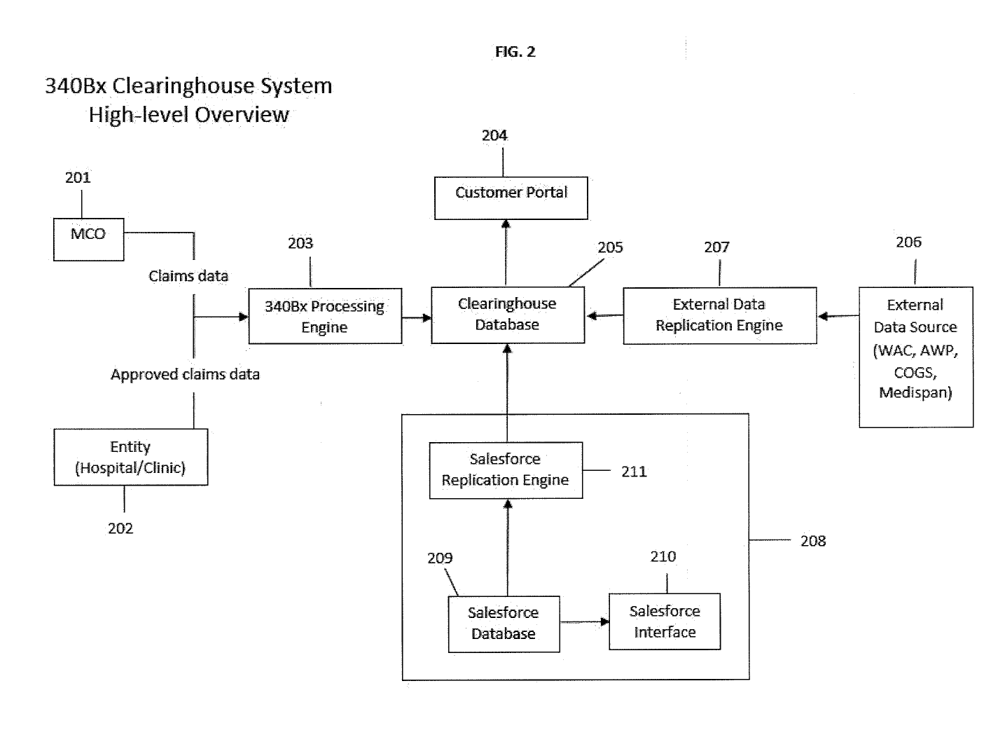

Reference is now made to FIG. 2 which depicts the overall architecture of the preferred embodiment of the 340B Clearinghouse. The depicted system is built around the following ancillary components: (1) A Processing Engine, 203, (2) A Customer Portal, 204, (3) Reporting capabilities, accessible through the Customer Portal, 204, and (4) An Administrative Interface (not shown).

The Clearinghouse Database as portrayed in FIG. 2, 205, is the focal point of this illustration. Applicant's Clearinghouse Database, 205, functions as an intermediary as it acquires information from multiple sources, manipulates said information and outputs the information to be represented to applicant's customers, via the Customer Portal, 204 or via backend reports. Applicant's clearinghouse leverages a processing system such as, most preferably the Microsoft (et. al.) development technology stack for the Processing Engine, Customer Portal and synchronization with Salesforce or other Interfaces for customer configuration.

FIG. 2 portrays both MCO's, 201, and Entities (Hospitals/Clinics), 202 or their 340B Administrators, submitting Medicaid claims data and approved claims data, respectively, to the applicants Processing Engine, 203. The preferred embodiments Processing Engine, 203, includes loading all inbound files, writing/sending outbound files, integrations to other systems (e.g., Salesforce, claim data) via DB, claims matching and evaluation. Varieties of options are configurable on a customer-by-customer database, and are stored in the applicants Clearinghouse processing database. The Processing Engine, 203, then sends said information to the Clearinghouse Database, 205.

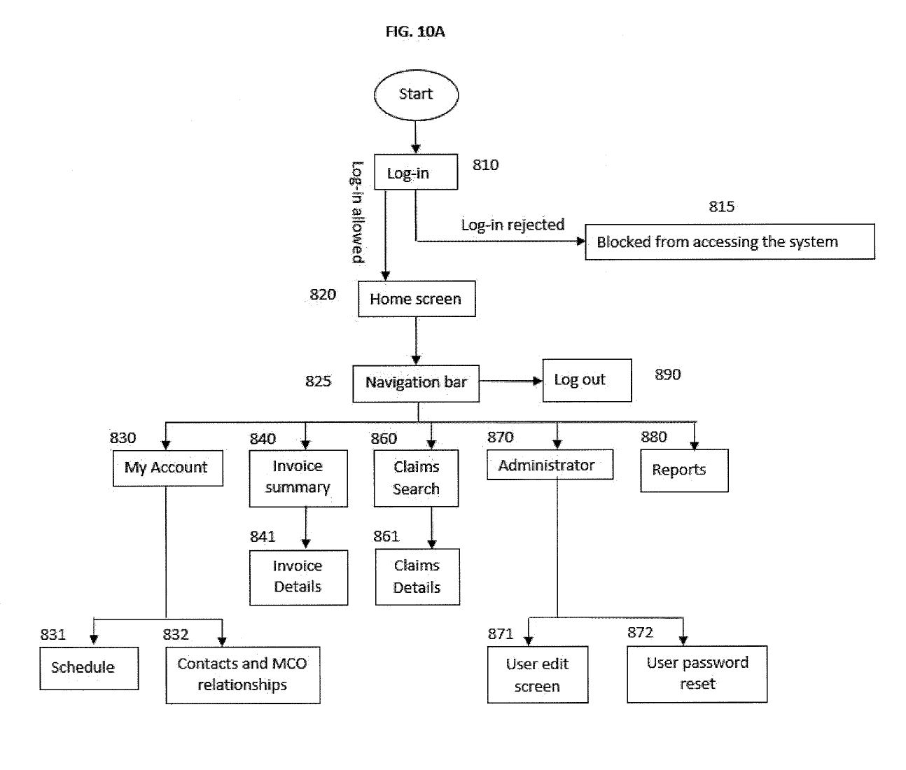

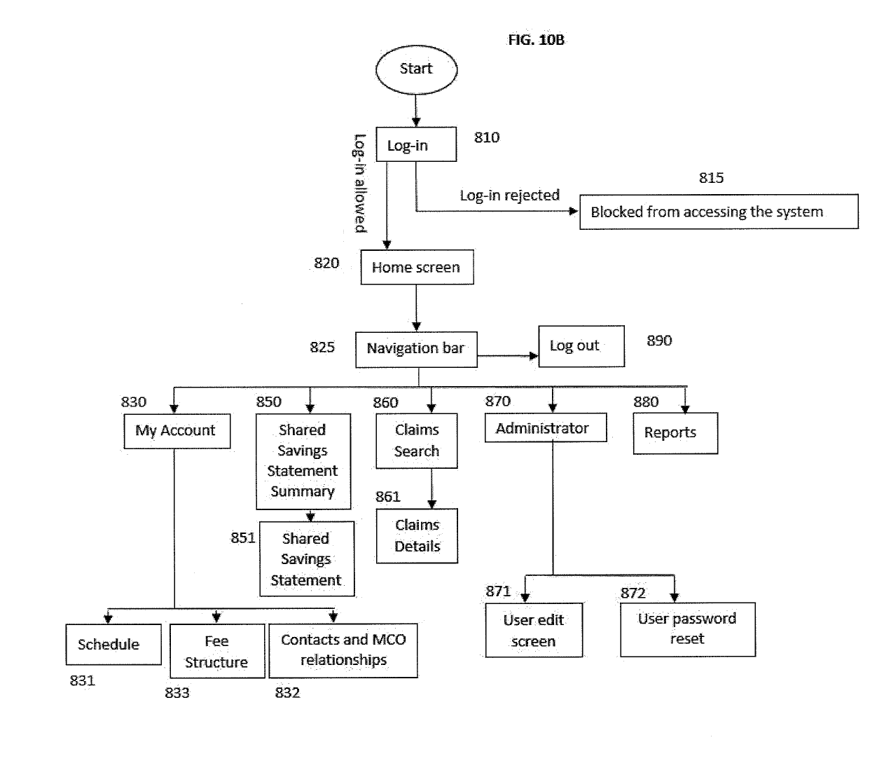

The embodiment portrayed in FIG. 2 contains a Customer Portal, 204, which allows both MCOs and Entities to each access their own individual portal to view, in real-time, 340B approved and matched claims, rolled back transactions, and various static and dynamic reports. The Customer Portal, 204, is a web-based module using, most preferably, the .net framework (ASP.Net/MVC or like) and connects to the Clearinghouse SQL Server database to provide up to the minute claims matching status, and shared savings reporting. Through this configuration, this system provides access for multiple user levels, and can access User Account Information, Shared Savings Summary statements, Shared Savings Detailed Breakdowns, Claims Search, organization specific user administration, and dynamic reporting. Further, this embodiment of the applicants Clearinghouse solution leverages the same Peer1 environment structure that is leveraged by the Cumulus solution. Detailed illustrations and descriptions of the various embodiments of both the MCO and Entity Customer Portals are represented in FIGS. 10A and 10B respectively.

The Reporting component is accessed through the Customer Portal, 204. Available reports are dependent on a multitude of factors, such as: whether the customer is an MCO or Entity and the level of access granted to the individual user. Reports are developed using the SSRS as well as various stored procedures. A detailed explanation and diagrams of the preferred embodiment of the customer portals are discussed and found in FIGS. 10A and 10B.

The Administrative module, not shown in FIG. 2, is an internal only interface that allows the applicants business implementation team to setup variable parameters for a customer to ensure that processing aligns with contractual terms. The module also provides tools to support implementation quality assurance and customer service. This functionality leverages the Salesforce Interface, 210, to manage the data, and the Microsoft stack and the Salesforce API to replicate data into the applicants Clearinghouse Database for use by the processing engine.

As noted above, the preferred embodiment of applicants Clearinghouse integrates with external technology and data sources in several ways. The first external sources of information are Text file and/or EDI file transfers from MCOs, 201 and Entities, 202. A second source of external information is received from a custom DLL for real-time integration between the clearinghouse and external sources, 206, such as WAC, AWP, COGS, Medispan data, etc. The multitude external Data Sources, 206, are inputted into the External Data Replication Engine, 7, where the data is replicated and later imported into the Clearinghouse database system for processing. The final source of external information originates from a separate DLL to facilitate data sharing with Salesforce system, 208. Salesforce has an existing API to allow data transfer into and out of the Salesforce instance, and SSIS automation provides non-real time critical data transfers. The Salesforce system, 208, is made up of a database, 209, and the salesforce interface, 210. The information is replicated and imported into the system through the Salesforce replication Engine, 211.

The architectural design of the preferred embodiment is portrayed by the component description coupled with a technical description which clarifies the claims processing solution. More particularly, the described embodiment utilizes an Extract/Transform/and Load (“ETL”) structure as it integrates data from multiple applications and sources. Generally, an ETL process extracts data from outside sources, then transforms it to fit the needs of the overall system, then loads it into the end target (most preferably a database). Thus, the ETL solution for the claims processing, of the present embodiment, embraces both design and technical details. The system for claims data processing is developed using, most preferably the SQL Server 2012, or a similar product that is commercially available. The various components within the SQL Server are primarily used for developing a scalable and efficient solution which includes the SSIS, SSRS and database engine. The SSIS is primarily used for the data load and transformation (ETL). Whereas the SQL Server database engine will be used to applying the core business logic, data storage as well as for archiving purposes. The SSRS is used for sending the MCO statements via email delivery and additional reports are created and developed for applicant's users which are accessible from backend and/or on the web.

The preferred embodiment of the claims processing solution is designed to handle a large volume of data efficiently and seamlessly to handle the ever increasing amount of data. Therefore, the SSIS packages are developed by leveraging the power of SQL Integration Services and also the highly efficient SQL Server database engine. The primary use of SSIS will be in importing the data from the FTP, decryption, data validation and transformation. At the same time the Claims processing system relies heavily on the SQL Server for performing the complex calculations and bulk updates. The preferred solution uses the SQL Stored procedures in many situations in order to achieve a better performance.

The preferred embodiment is developed using the optimized SQL queries, properly designed indexes, making sure various processes are distributed to avoid heavy load in the database engine on a particular time and efficiently designed table partitioning to minimize the query time. Also database files will use different RAID configurations for storing data to improve the IO performance.

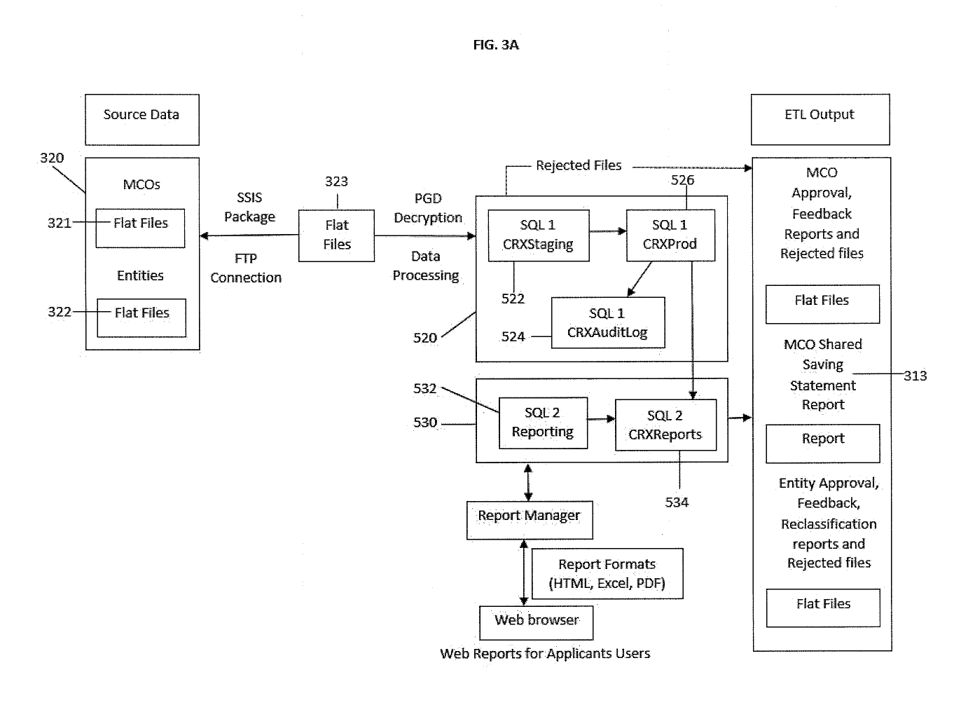

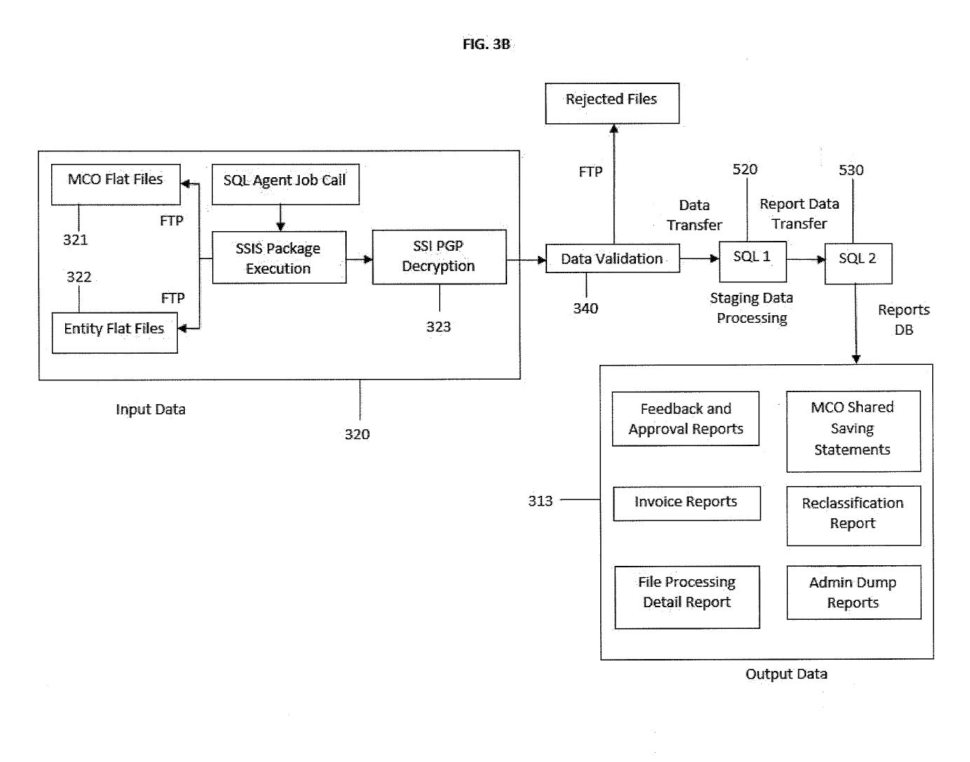

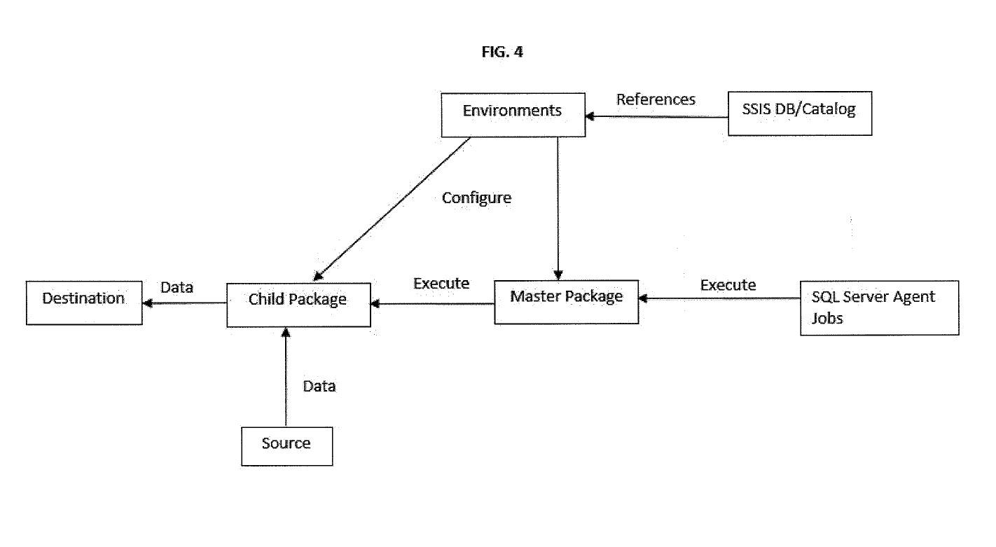

A claims ETL process extracts data from various input sources. FIG. 3A portrays two input source Flat Files from Entities, 322, and MCO's, 321 and Lookup Data. The flat files reside in a FTP location whereas the lookup data resides in the SQL Server database. Next, the transformation stage is where the data goes through several validations and calculations. Finally, there will be several output files and reports as part of the process once the ETL is completed successfully. Such Output Reports are: Feedback Reports, Approval Reports, Shared Saving Statements, Invoice Reports, Reclassification Report, and File Processing Detail Report as represented in FIG. 3A, 313 and FIG. 3A, 313. The SQL Server Integration Services will also utilize the ETL packages using SSIS for data movement, validations and transformations. FIG. 4 portrays how the SQL server integrates with various systems, data movement and transformations. Specifically, FIG. 4 depicts a schematic of master and child packages, during the ETL process, as all configurable parameters are stored in one environment within the SSIS catalog.

FIGS. 3A and 3B are used in tandem to portray an exemplary data flow diagrams depicting ETL process as the data moves through the preferred embodiment of the claims processing system. FIG. 3A portrays an exemplary block illustration of Data Flow through the system. The MCO and Entity flat files, 321, 322 respectively, are copied from the FTP location, 320, and kept in the SQL1 server, 520, in a Temporary folder. Also, a copy of the encrypted file is created and kept in a separate FTP archive location, not shown in drawings. The system will decrypt the file, 323, and start data validation, 340. The Data valuation stage validates the data and rejects all non-conforming data. The data validation process is discussed in further details below. Then all of the properly validated data is transferred to SQL1 Staging server for further processing. The final processed data is stored in the SQL 1 “CRXProd” database, 526. The reporting data is then transferred from the SQL1 Staging Data Processing Database, 520, particularly, “CRXProd”, 526, to the SQL2 database, 530, particularly, “CRXReports”, 534, where reports are generated. A separate database is used to prevent corruption of the data when reports are generated. Finally the system generates all the reports from “CRXReports” database, 534.

Correspondingly, FIG. 3A depicts the preferred embodiment of the high level architecture of the technical parameters. Generally, the source data, 320, from both MCO's, 321, and Entities, 222, is decrypted, validated, transferred for processing to SQL 1, 520, then the report data is transferred to SQL 2, 530, where finally the output data is placed in the Reports Database, 313.

As portrayed in FIG. 3A, the preferred embodiment of SQL 1, 520, is made up of three different files, are “CRXStaging” 522, “CRXAuditLog” 524, and “CRXProd”, 526. The staging server, CRXStaging, 522, is made up of a table which simply contains an (1) Index, (2) Schema Name, (3) Table Description and a (4) Table Name. The “CRXStaging”, 522, contains two separate indexes, one containing inputs for MCO's while the other is for Entity inputs. Each index relates to data corresponding to a specific MCO or Entity. The Schema Name is special schema known as “dbo” (database-owner). The Table Description is a rough description of the table to easily identify it (i.e. Input validated data coming from flat file). The Table Name is merely the name of the table, for simplicity the preferred embodiment names the tables Input_MCO, and Input_Entity. Each index in the Staging Server, CRXStaging, 522, for the MCO, and Entity contain input information for both MCO's and Entities, such as (1) Date Time Stamp, (2) BIN Number, (3) Processor Control Number, (4) Service Provider ID, (5) Transaction Code, (6) Date of Service, (7) Patient First Name, (8) Patient Last Name, (9) Patient Gender, (10) Other Coverage Code, (11) Prescription Reference Number, (12) Fill Number, (13) Provider Service ID, (14) Quantity Dispensed, (15) Transaction Response Status, (16) Total Amount Paid, (17) Patient Pay Amount, (18) Dispensing Fee Paid, (19) Switch Indicator, (20) Group ID, (21) File Type and Version, (22) Validate Medication for Clearinghouse, (23) COGS, (24) State, (25) ETLID, (26) Modified Date, (27) Rejection Code, (28) Rejection Description and similar inputted information.

The proposed SQL 1 server, 520, contains a Production Table, herein referred to as “CRXProd”, 526. The Production Table, “CRXProd”, 526, receives the data from the Staging tables, 522, for processing. The preferred embodiment of the “CRXProd”, 526, contains 25 separate indexes where each index contains a (1) Schema Name, (2) Table Name and a (3) Table Description. The Schema Name is special schema known as “dbo” (database-owner) or an Admin. The Table Name is the name of each nested block of information contained within each index. The Table Description is a rough description of the index/table name to easily identify it. For example, in this embodiment, table descriptions (without the nested information) are: Medicine and Pricing Details; State and MCO with Share of State; Pharmacy Allowance Details; MCO and Entity Contract Details; Tiered Pricing Breakup Details; MCO configuration Details; Entity Configuration Details; Rejection Codes; Various information regarding the Claims processing for both MCO's and Entities; Archiving Configuration; Details on how output report is delivered (i.e., FTP or Email delivery); Details about the shared saving split percentage; both MCO and Entities approved data, invoice data, rejection retails; both MCO and Entities Feedback reports; both MCO and Entities approval reports; and Reclassification data.

Within each index contained within “CRXProd”, 526, is nested information stored for later creating the reports. For example, within the first index titled “Medicine and Pricing details,” the nested information contained within it includes such information as: COGS ID, the medication Name, NDC Number, Cost Type, Cost, Is Branded, Start Date, End Date, and Modified Date. Correspondingly, each index within, “CRXProd”, 526, contains a separate nested block of information.

The last database contained within the preferred embodiment of the SQL 1 server, 520, is an Auditing Log. In this illustration it is referred to as “CRXAuditLog”, 524. Information from the CRXProd, 526, is transferred to both CRXAuditLog, 524, and to SQL2, 530. The Audit Log functions of the SQL1, 524, deal directly with the security of the system. The purpose of these auditing tables is to capture all the necessary information which is part of feedback report. This feedback report is sent out to Entities and MCO's every time on every successful execution of claims data processing. The feedback Report is discussed in further details below.

The data is transferred from the SQL 1 server, 520, to the SQL 2 server, 530, to prevent compromising or degradation of data as the reports are created. The proposed SQL 2 server, 530, also contains a Production Table, where in this illustration it is referred to as “CRXReports”, 534. The preferred embodiment of the “CRXReports”, 534, contains nine separate indexes where each index is described by a (1) Schema Name, (2) Table Name and a (2) Table Description. The Schema Name is a special schema known as “dbo” (database-owner). The Table Name is the name of each nested block of information contained within each index. The Table Description is a rough description of the index to easily identify what information it contains. Contained within each index is nested information which is collected and stored for later processing the reports. For example, in this embodiment, table descriptions (without the nested information) are: MCO Feedback Report Data; Entity Feedback Report Data; Entity Approval Data; MCO, Approval Data; Reclassifications Report Data; and various Admin data dump for—State details, Claims details, and Entity details.

Within each index contained within “CRXReports”, 534, is nested information stored for later creating the reports. For example, within the first index, “MCO Feedback Report Data, the nested information contained within it includes such information as: Date Time Stamp, BIN Number, Processor Control Number., Service Provider ID, Transaction Code, Date of Service, Patient First and Last Name, Patent Biographical information (Date of Birth, Gender etc.), Other Coverage Code, Prescription Reference Number, Fill Number, Product Service ID, Prescriber ID, Quantity Dispensed, Transaction Response Status, Total Amount Paid, Patient Pay Amount, Dispensing Fee Paid, Switch Indicator, Group ID, COGS, State, Status of Claim, and etc. Correspondingly, each index within, “CRXProd”, 526, contains a separate nested block of information.

Additionally, the SQL 2 server, 530, contains a database called “CRXArchive”, 536. This database contains all archived data coming from the main MCO and Entity claims data table as a duplicate to prevent data degradation.

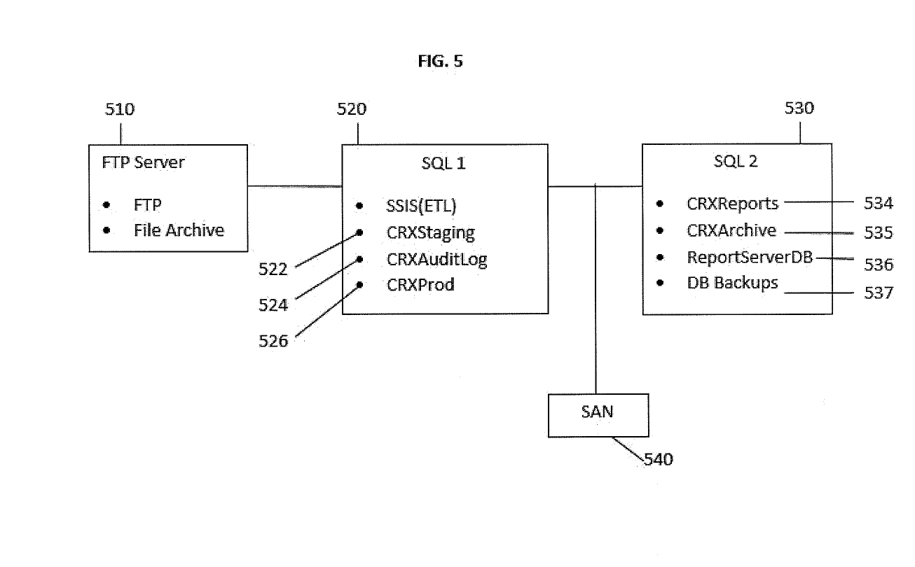

FIG. 5 portrays the preferred server architecture which represents the technical platform for the system. The FTP Server, 510, comprises both Input and Output files. Additionally, files archiving is also stored in FTP server. The SQL 1 server, 520, comprises Integration Services for running the ETL packages, staging, auditing, and logging and production database. The proposed file names on the SQL 1 server, 520, are “CRXStaging”, 522, “CRXAuditLog”, 524, and “CRXProd”, 526, the substance of each file is discussed above. The Reports data is further moved to the SQL 2 server, 530, for reporting purpose. The SQL 2 server, 530, will be hosting the SQL Services Reporting Server along with the Reporting database. The reason for separating the Reporting Server into another instance is making sure Reporting is separated from the data processing activities preventing no performance degradation while accessing or delivering the reports. In addition, all the reports will be using this server as a data source. The proposed file names of the 4 files contained in the SQL 2 server are “CRXReports,” 534, “CRXArchive,” 536, “ReportServerDB”, 536, and “DBBackUps”, 537.

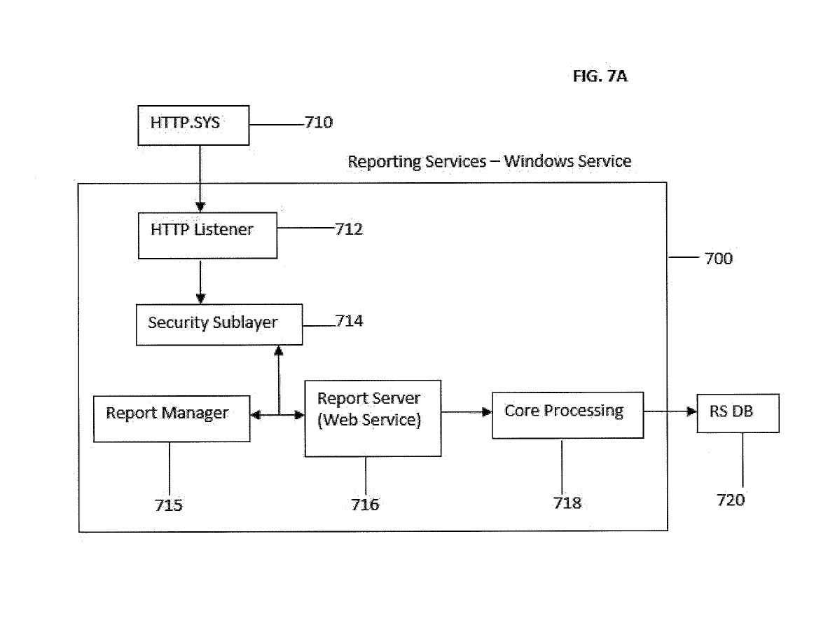

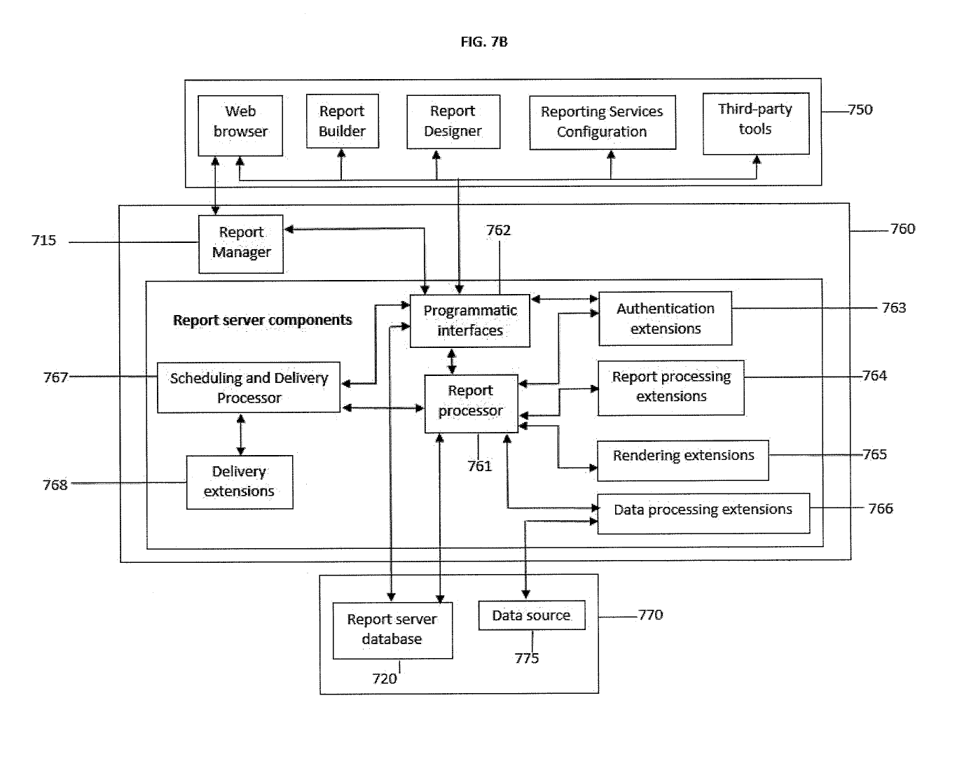

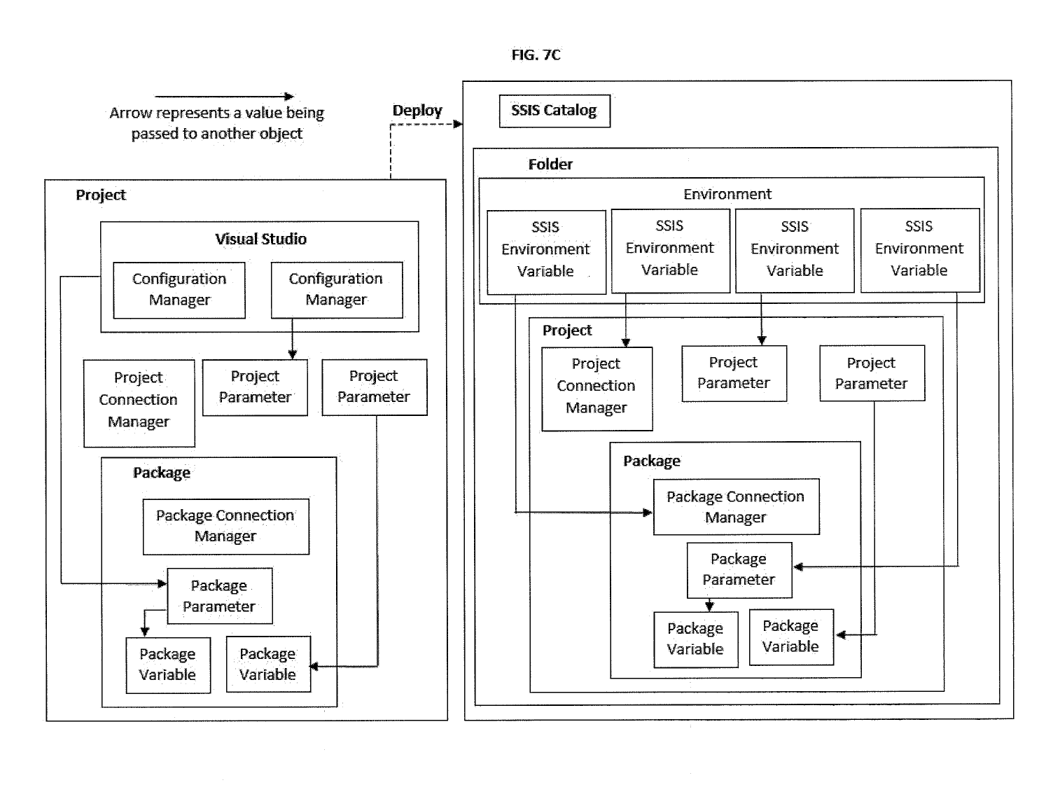

FIG. 7C portrays an embodiment of the SSIS Deployment. The Claims processing solution will be using the most preferably the new SQL Server 2012 SSIS Catalog deployment feature, or a similar available product. All the SSIS packages will be deployed in a fully secured SSIS catalog database. In the catalog database the administrators will have options to change the SSIS configuration details.

Additional components of the preferred embodiments' security include the file security/data encryption, the SQL Server Integration Services, Logging & Error Handling, Auditing, SSRS and Email Subscriptions, Data Partitioning, and Database Archiving.

The preferred embodiment utilizes six separate protocols for security, to meet or exceed HIPAA requirements. To be HIPAA compliant, the preferred embodiment utilizes such behaviors as: SQL Authentication, Windows Authentication, Auditing, Confidentiality, Data integrity, and Backup.

The aforementioned six protocols which control the security and maintaining of HIPAA regulations in the preferred embodiment are simply illustrated here with a full detailed discussion to follow. The Authentication of both SQL and Windows are native to their prospective programming. The system will have an Auditing function, 524, wherein both the database and sever instance logs will be created and stored on a separate physical device. Confidentiality is maintained as the sensitive database, “CRXProd”, 526, will be encrypted. Data integrity will be maintained as data sent across the network cannot be modified by a tier. Finally, database backups will be created and stored on a separate physical device. To facilitate secure communications between the SSIS packages and SQL 1 server and between the SQL 1 server and the SQL 2 server, the preferred embodiment will utilize both the SQL Server and Windows authentication. Under the SQL Server Authentication one must log in using the required username and password. The Windows Authentication uses an integrated active directory which does not require password.

The internal auditing system of the preferred embodiment possesses tables of data stored under the data base called “CRXAusitLog”, 524. As previously discussed the purpose of the auditing tables is to capture all the necessary information which is part of feedback report.

Data integrity is maintained throughout the ETL and data processing. Specifically, the solution uses all the configuration information like FTP location, file decryption key, MCO and Entity setup information from the SQL Lookup tables in SSIS packages. This will make sure any changes happened in the lookup data will automatically be reflected in SSIS packages without any change in the code.

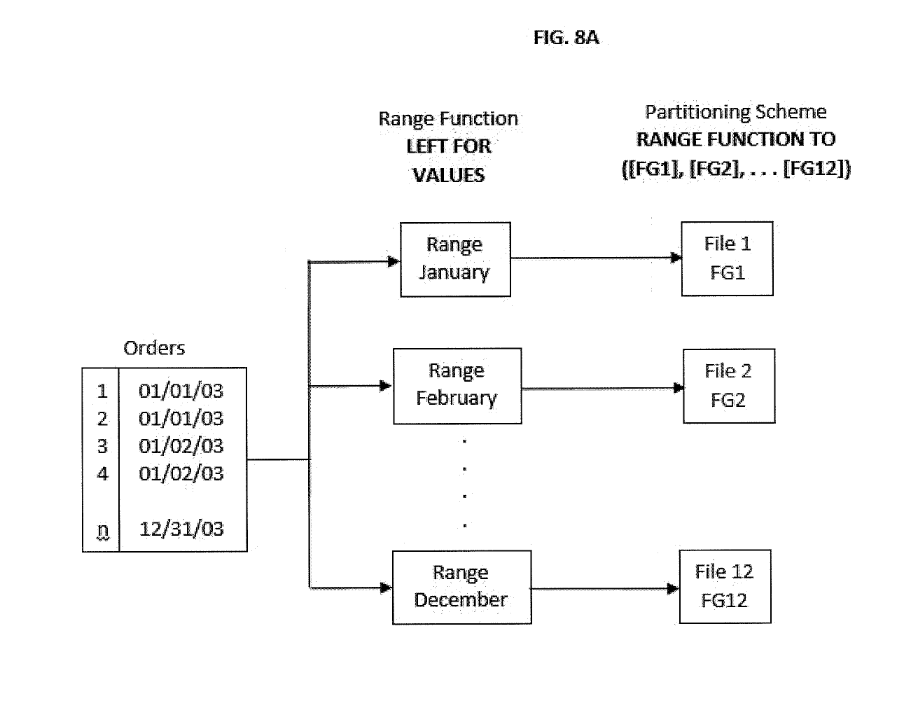

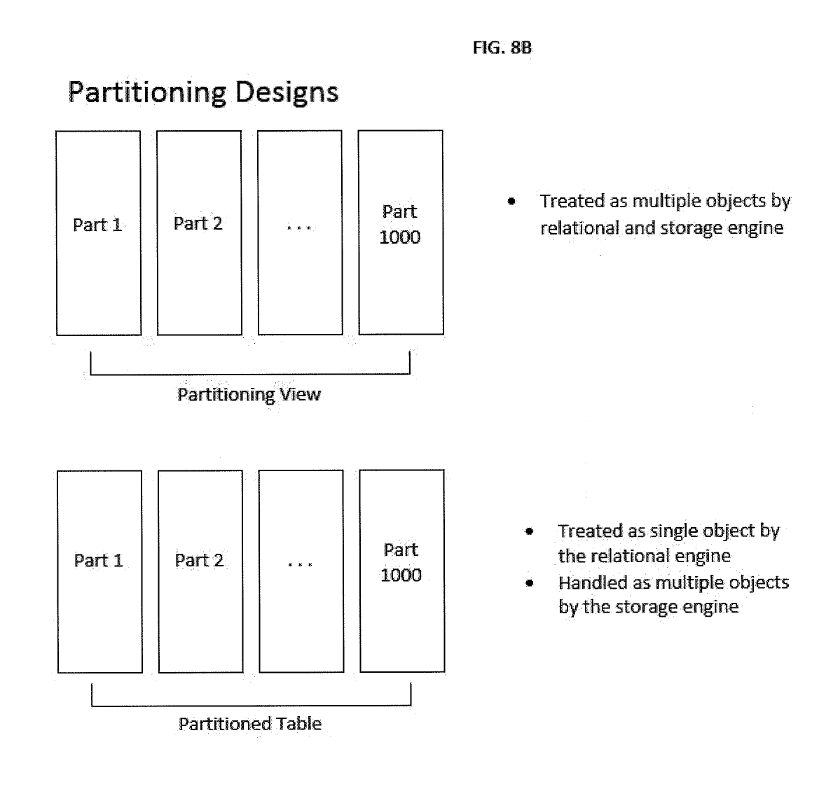

Another means of preserving data integrity in the preferred embodiment is by utilizing a strong data partitioning component. FIGS. 8A and 8B portray an illustration of the Data Partitioning component of the preferred embodiment. The preferred embodiment of the claims processing solution coupled with the SQL Server partitioning features confirms that the solution is scalable to handle large volumes of data. The table partitioning will distribute the data across multiple file groups. The preferred Embodiment partitions the data horizontally so that groups of rows are mapped into individual partitions. The table partitioning will help in transferring the data quickly and efficiently resulting in better query performance.

The preferred embodiment of the claims processing solution has a data archiving functionality in place to make sure historical data is available in storage area network (hereinafter referred to as “SAN”). The incremental archiving solution will be implemented in SQL Server which will move the old data from main tables to the archive tables in regular predetermined intervals. At the same time, the data in the archived tables will always be accessible whenever needed. The data archiving will make sure a particular table is not too big in terms of number of rows, relating directly to limiting the size of a file, and hence will help in improving the overall 10 performance.

The file encryption utilizes PGP encryption or a similar product that is commercially available at the time, for encrypting and decrypting the file. The preferred embodiment encrypts the input files with the decryption key stored in the database. The SSIS will be used to decrypt the file before it starts processing data. The output files are again encrypted before moving to the FTP location.

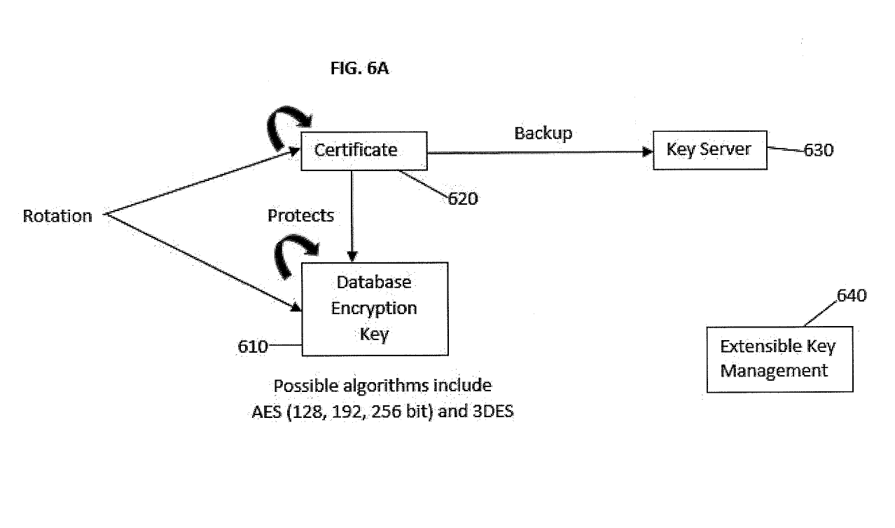

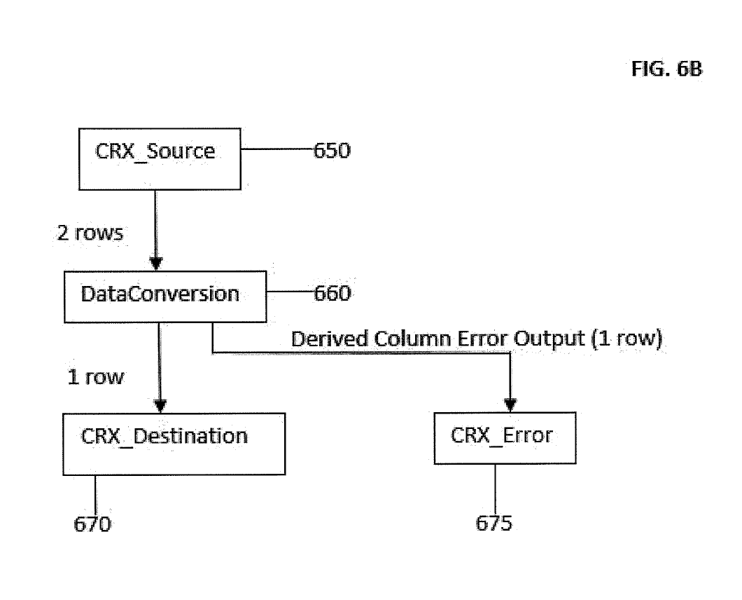

SQL Server uses encryption keys to help secure data that is stored in the server database. FIG. 6A is an illustration of an embodiment of the preferred database encryption method in compliance with HIPAA regulations. This embodiment will implement the database level encryption for some of the databases where the sensitive information is stored, specifically, the “CRXProd” and “CRXArchive” databases will be encrypted. The encryption includes encrypting the data, log files and the backup files. The claim processing solution will use the SQL Server's transparent data key encryption (TDE) technique (as portrayed in FIG. 6A), or a similar product that is commercially available, for encrypting the SQL Server database, log and backup files. TDE performs real-time I/O encryption and decryption of the data and log files. The encryption uses a database encryption key (DEK), 610, which is stored in the database boot record. The contents of this boot page are not encrypted; thus the DEK, 610, has to be encrypted by using a certificate, 620, stored in the key server, 630. After it is secured, the database can be restored by using the correct certificate. Thus, on opening the encrypted databases the SQL Server first opens up the boot page, which contains the DEK, 610, then it finds the certificate, 620. Once the certificate, 620 is located, it can then be used to decrypt the DEK, 610. Finally, this decrypted DEK, 610 is used to decrypt the actual data pages as they are read from and written to disk.

In addition to the security, the preferred embodiment also maintains a log depicting all errors that occurred during the data processing. The preferred embodiment of the Claims process solution will log each and every event while the ETL is running. The logged data will be stored in SQL Server under the “CRXAuditLog” database, 524. This database will also capture the warnings and error messages in case of any problems. The purpose is to make sure that any ETL issues are easily traced back by the server admins. As previously mentioned the “CRXAuditLog” database, 524, is used for capturing audit information, under a different schema name, for the feedback report. The FIG. 6B depiction of how the system logs errors. Starting with the source information, 650, the data is converted and processed during the data conversion stage, 660. Once the data is converted to the proper format, as utilized by the embodied system, one row of data at a time is checked to verify no errors exist. If the row is error free, it is moved to its proper destination, 670. However, if the row of data contains an error is placed in the error log, 675.

The solution will send email notifications to administrators every time the ETL runs. These notifications are an acknowledgement of a successful ETL execution and include any failures if they occur. Errors will be kept in a separate error tables. The ETL solution knows where to start the process next time it runs in the case any failure occurred. The purpose is to make sure data is not corrupted in the case that the last ETL process did not run successfully completely.

FIGS. 7A and 7B depicts the SSRS and Email Subscriptions and the SSRS Native Mode Deployment as utilized by the preferred embodiment. SSRS is SQL server based report generation software manufactured by Windows. The preferred embodiment uses SSRS for generating and sending out Shared Saving Statements and Invoice reports; however any similar software product that is commercially can also be utilized.

Reports are created once the ETL processing completed. These reports will be sent out to the various subscribed email addresses in either PDF or excel format. Also, few parameterized reports are developed for internal use of applicant users which could be accessed on the web. SSRS uses fully secure Http sys protocol making sure reports are secure when accessed in the web. FIG. 7A illustrates a block diagram of the SQL Reporting services (SSRS) as it generates reports for the system; specifically, how Reporting service requests are handled through the components of SSRS architecture. All requests are received by the Reporting server's operating system through HTTP.SYS Driver, 710. HTTP.SYS routes the communication directly to the Reporting Services Windows Service, 700, which handles all on-demand, interactive report processing. Once, the communication is within Reporting Services Windows Service, 700, the HTTP.SYS Driver, 710, routes the communication to the reporting service's Web service, 716. HTTP Listener, 712, receives the request which is rerouted by HTTP .SYS, 710. HTTP Listener, 712, transfers the request to Security sub layer (SSL), 714, for authentication. Once a user is authorized by the SSL, 714, the user communication is redirected to either Report Manager, 715, or Report Server, 716, which is hosted in the Reporting Services web services, 716. Report Manager, 715 and Report Server, 716, read the report definition, report details like parameter, etc. with the assistance of the Core Processing unit, 718. Further, the Core Processing Unit, 718, conducts the report processing, and subscription management. Upon completion of the report processing of the SSRS, the report output transferred to the Reporting Services Database, 720, and is then is rendered on a report viewer. The Report Server Database, 720, is a SQL server database which is used as a data dictionary about reports.

FIG. 7B depicts the reporting services architecture in further technical detail. The diagram portrays a three-tier system of a reporting services deployment as well as the flow of requests and data among the various server components. The three tiers of the FIG. 7B are: the presentation tier, 750, which contains the client applications and custom tools; the middle tier, 760, which is comprised of the report server components; and the Data Tier, 770, comprising the report server database, 720, and data source, 775.

The presentation tier, 750, encompasses the client external applications and custom tools in creating the report. The middle tier, 760, is a web interface for managing and generating various reports. The report Manager, 715, is a browser application that provides front end access to a user, granting the user access to the reporting service web service, as depicted in FIG. 7A. The Report Processor, 761, receives the request for a particular report, which includes the desired formatting and parameters to be included in the report. The Report Processor, 761, then retrieves all report data and preforms all necessary processing and transformation on the data. Various extensions, are be added to the system to support the data processing and report generation. The Authentication Extension, 763, is a security protocol as it authenticates and authorizes users to a report server. The Report Processing extension, 764, is optional as it provides custom report processing fro report items. The Rendering Extension, 765, transforms the data layout from the report processor to a device specific format (i.e. —Microsoft Excel, PDF, Microsoft Word, etc.). The Data Processing Extension, 766, is used to query a data source and return a flattened row set. The Schedule and Delivery Processor, 767, uses the Delivery Extension, 768, to deliver reports to the defined output. Through the Delivery Extension, 768, reports are to deliver to various locations (i.e. email, a specific location, etc.), based on the users subscription to the reports. The final tier as depicted in FIG. 7B contains the Report Server Database, 720, and the Data Source, 775.

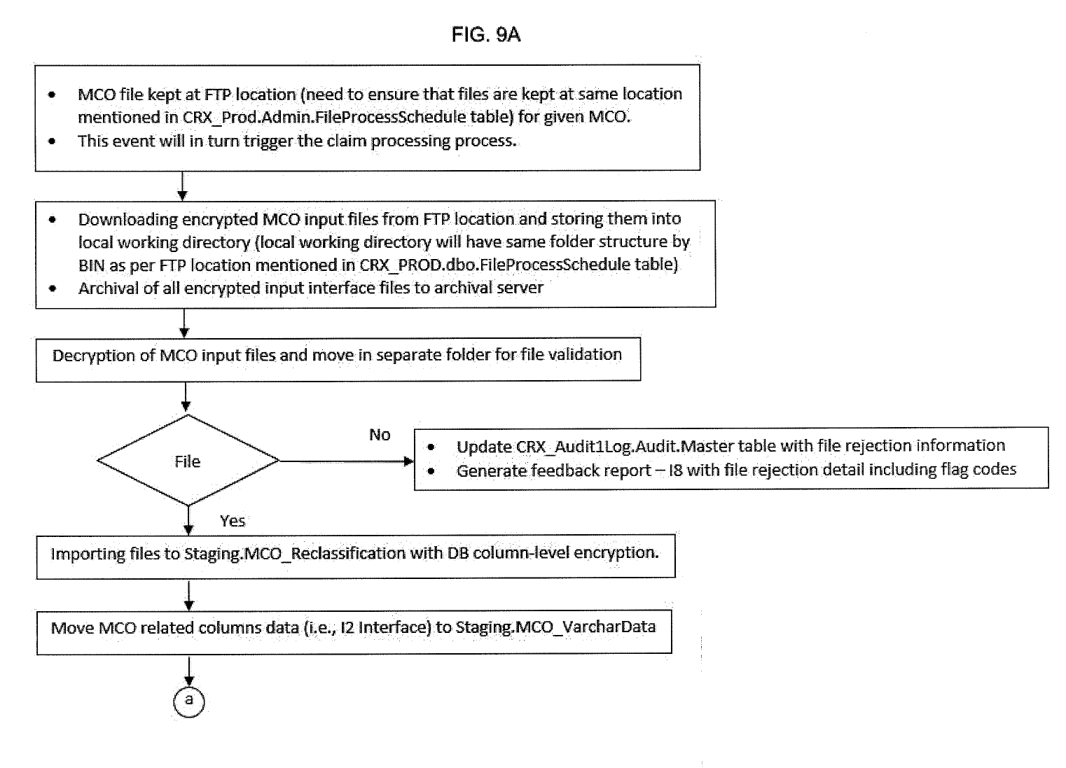

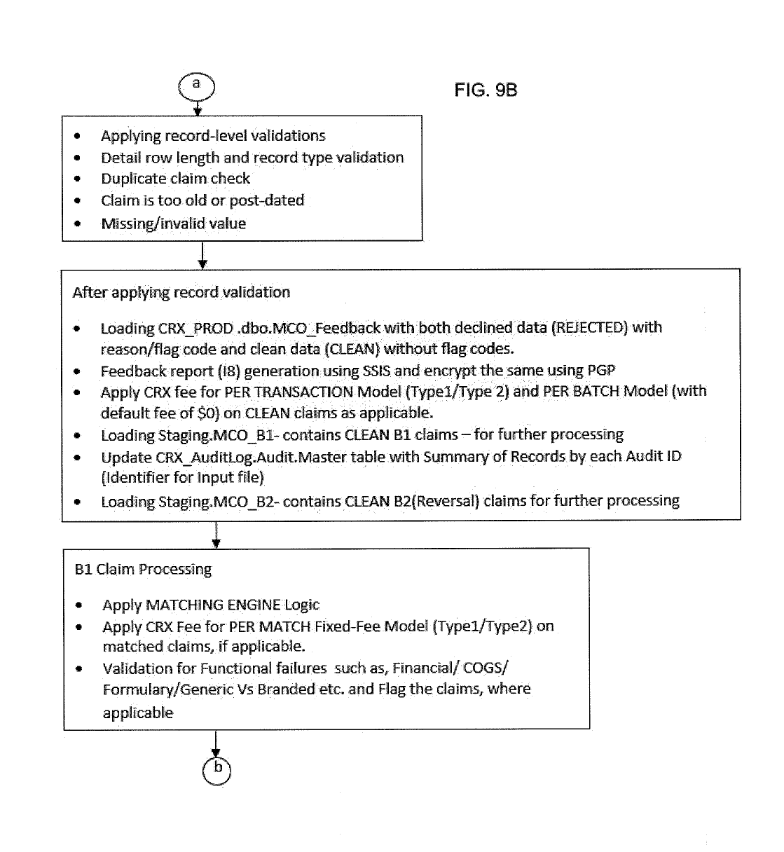

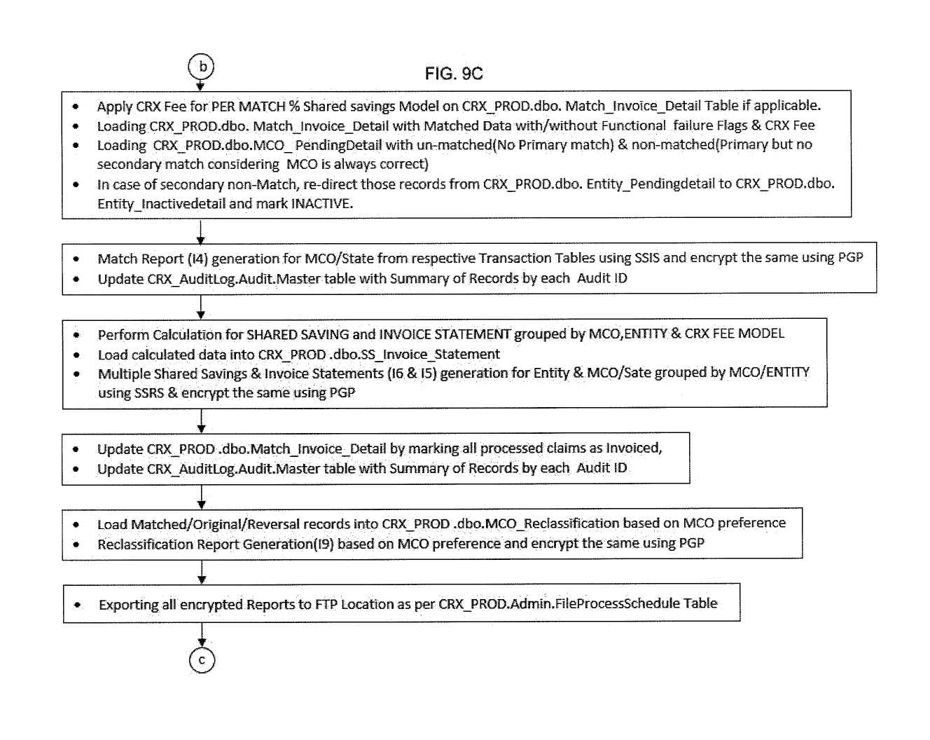

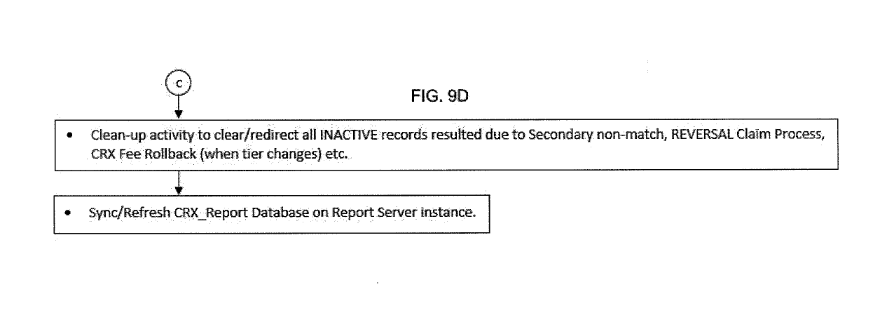

The various embodiments of the claims processing solution encompass certain directives that control the flow of information and data processing as the system identifies and reports 340B claims for both MCO's and various Entities. FIG. 9 portrays an exemplary flow chart detailing the preferred embodiments processing of information. The data interchange between the MCO's and safety net providers includes, but is not limited to: approved claims files from MCO and safety net providers; approval for claims to MCO and safety net providers; and reports and invoices.

The preferred embodiment of the data interchange is built upon nine basic parameters that govern the system and provide traceability. The systems architecture and design is flexible to handle an ever increasing load of processing data as new MCOs and Entities sign up. Secondly, the system possesses security and privacy protocols in compliance with HIPAA policies. Thirdly, the system cross references at least the following information, Effective dated WAC, AWP, Effective dated COGS, and Brand vs. Generic. Next, the system imports and stores incoming files submitted by MCOs and Entities containing claims information such as, Validate file inputs, and Filter for duplicates. The system then processes claims data submitted/imported from MCOs and Entities to calculate shared saving for MCOs and Entities based on specific criteria: Apply financial, formulary, COGS tolerance failure; Process reversals; and Calculate shared savings. Next, the system creates invoices and reports based on the calculated shared savings. The reports and invoices are then sent out to various parties—the reports of all the matches are sent to the various MCOs and to the State; the invoices are sent to all of the Entities; a shared saving statement is sent to the MCO's; and finally, a report on Flagged “Failed Financial Filter” records are sent to the MCO's. The system then Archives and deletes the data. Finally, the system shall generate two final reports: a Claims Status Report and an Admin Data Dump.

As already described, the preferred embodiment's architecture and design should be flexible and scalable to handle the load resulting from large and ever increasing amounts of claims as new MCO's, Entities and safety net providers sign up across the country. Since many MCO's operate in more than one state, the processing protocols may vary per State and per MCO.

To ensure data privacy is maintained, the system complies with HIPAA regulations which include data encryption and secure transmissions of sensitive information. The database is encrypted. To access the database and clearinghouse system, all users must pass the secured authentication process. The preferred security protocols to access the system has a two-step authentication for new users during setup which includes: (1) When a user is set up, an email will be sent to the user to verify his identity, and (2) When the authentication link is clicked, the security system shall check the email address and temporary password before letting the user set a new password. Additionally, the system shall require a strong password (where such features include: 8 characters long, at least one uppercase latter, at least one character, and at least one number). After the data import process is complete, the system deletes the decrypted incoming claims file. If applicable, the system also encrypts files when it sends approval statements, feedback statements, shared savings statements and invoices either via FTP or email. Additionally, the system retains the original encrypted file sent by MCO/Entity for auditing.

To process claims in the clearinghouse, each claim will have to pass pre-defined business rules which include: Brand Name Medications, Financial, and Formulary Tests etc. Additionally, medical equipment is included in processing claims.

The preferred embodiment relies on external data for cross-referencing and retrieving information regarding Costs of Goods Sold (COGS), Wholesale Acquisition Costs (WAC), brand v. generic, etc. The system will cross reference the following information from external sources: effective dated WAC or AWP (depending on the State, when calculating savings and viability of the claim); effective dated COGS; and Brand v. Generic.

WAC and AWP information is loaded into the system from an external source. This information is stored in the system using effective dates to maintain history and to make sure the correct price is used for cross reference based on date of service for the claim being processed.

The system also, cross references COGS, from an external source, when calculating savings and viability of the claim. This information is stored in the system using effective dates to maintain history and to make sure the correct price is used for cross reference based on date of service for the claim being processed.

Additionally, the system can cross reference MediSpan data, uploaded from an external source, to determine if the claim being processed is Generic or Brand. The system has the ability to pull data for WAC, AWP, COGS and Band vs. Generic to use for matching engine. The script for pulling data is done on either an incremental or full update mode.

The preferred embodiment imports and stores incoming files containing claim information submitted by both MCOs and Entities. The system validates the input file, and Filter the files for duplicates.

The system imports and validates the data that is submitted by the MCOs. Initially, the system imports all files available in the respective FTP location. To validate the input data, the system will require all input information to be placed in rows. If any row does not match the proper format, then that specific row is rejected. There should be three record types in the file: PA, DE, and PT. There should be a single Header (PA) and a single trailer (PT) each. If there are multiple PA rows or PT rows, then the entire file should be rejected. Once the input information is placed into its proper row, the system confirms all the required fields are available. If any required field is missing in a row, the row is rejected. For example the preferred embodiments required fields are: Adjudication Date, Adjudication Time, Service Provider ID, Date of Service, Prescription Reference number, Fill Number, Adjustment Type, Product Service ID, Prescriber ID, Quantity Dispensed, Total Amount Paid, Patient Pay Amount, Dispensing Fee, and Group ID. Additionally, the system also validates that all the field data types and lengths match. Field descriptions and file layouts have the following protocols for data transfer. All files are in a plain text file with the .TXT extension; however once encrypted, the file may have an optional PGP extension. Fields are separated by the “pipe” character (e.g. “|”); whereas each record is be separated by a new line. If there is no data for the field that that file will be NULL, denoted by an empty string (e.g. “∥”). If the there is a mismatch for a row, the entire row is rejected. The system shall check for duplicate submission for each row in the file being imported for the MCO. The system identifies duplicates by matching the following columns: Transaction ID, Service Provider ID, Date of Service, Prescription Reference Number, Fill Number, Adjustment Type, Adjudication Date, and Adjudication Time. If a row is identified as a duplicate submission, that row will not be used for matching against Entity data. Further, the MCO will be notified in their feedback report.

Next, the system imports and validates the data that is submitted by the Entity. Initially, the system imports all files available in the respective FTP location. To validate the input data the system requires all input information to be placed in rows with their columns based on the I1 File format. If any row is missing any columns, the entire file is rejected. If the entire file is rejected, then the feedback file (I7) will have only 1 row stating that the file is being rejected because it does not match the number of columns expected. For example the preferred embodiments required fields are: Adjudication Date, Adjudication Time, Service Provider ID, Date of Service, Prescription Reference number, Fill Number, Adjustment Type, Product Service ID, Prescriber ID, Quantity Dispensed, Total Amount Paid, Patient Pay Amount, Dispensing Fee, and Group ID. The system then validates that the field data type and length match. If there is a mismatched row, that row is rejected. The system then checks for duplicate submission for each ROW in the file being imported for the Entity. System shall identify a duplicate submission by matching the following columns: Transaction ID, Service Provider ID, Date of Service, Prescription Reference Number, Fill Number, Adjustment Type, Adjudication Date, and Adjudication Time. If a row is identified as a duplicate submission, that ROW will not be used for matching against Entity data. Additionally, the MCO will be notified in the feedback report. Under the preferred embodiment no feedback reports are combined for file rejections. For example, if an entity submits 10 files and 2 files are rejected because of failed validation the entity will get 8 processed feedback reports and 2 failed feedback reports for a total of 10 files (which matches the original number of submissions).

Once the claims data from MCOs and Entities are submitted, imported and validated, the system then processes the information to calculate shared savings for MCOs and Entities. If there is any shared savings it is split between the MCO and Entity, with the percentage split setup at the MCO level. The system matches records, which have been successfully imported/submitted by MCO's and Entity's which have not been already processed, using primary and a secondary match. The primary filter used to match a record looks at: Adjudication date, Adjudication time, Service provider ID, Date of service, Prescription reference number and fill number. If the primary filters match then a secondary filter is applied, which looks at demographics, is applied and reviews: Product Service ID, Prescriber ID, Quantity dispensed. If the record matches on both the primary and secondary filter, it is considered a successful match. However, if a record matches on primary but not on the secondary filter, the row is Flagged but matched and feedback is provided to the appropriate party. System is capable of implementing Primary and/or Secondary match criteria (if required).

The system runs the 4 different filters to determine the amount of shared shavings for the records that are matched: (1) Brand vs. Generic Filter; (2) Financial Filter; (3) Formulary Filter; and (4) COGS Filter. Under the Brand vs. Generic Filter the system checks if the MCO for the claim will process generic drugs. If the MCO does not accept generic, that information is flagged for reporting purposes later. The Financial Filter acts as a simple equation in which the Shared Savings is equal to the “Total Paid”—“Allowance”—“340B COGS”—“Savings for State”. Under this filter the “Total Paid” is defined as the amount submitted by the MCO in the total paid column and includes the patients co-pay. “Allowance” is defined either at the MCO level or pharmacy level using the in house pharmacy/special pharmacy value. When setting up a new MCO the “Allowance” value is defined. However when a special pharmacy or an in-house pharmacy is used, an exception will be added later. The “340B COGS” is provided as an external feed which will be used as a lookup. The “Savings for State” is dependent on the State the claim is from. Some States require certain MCO's to pay a percentage of either WAC or AWP, for all claims as part of their contract. Therefore, this value changes depending on the state the claim is from. The information for determining the States cut is submitted by the MCO (not Entity). Same States can have contractual agreements with multiple MCO's, wherein each MCO has a different State cut setting. Under the Formulary Filter, if any 340B medication price is not available in the lookup information, the record is flagged. Under the COGS Filter, the system cross checks the COGS for a claim submitted by the entity to match against the COGS effective date available in the system. The record will be flagged if the COGS do not fall in the range of +/−25%. Additionally, the MCO's do not submit a value under the COGS filter. After the Financial, Formulary, COGS tolerance failure filters are applied, the system then processes reversals. When a claim is reversed, the amounts of Total Paid, Patient Co-Pay, Dispensing Fee, are reversed and shown as a negative amount. The system then calculates the Shared Savings.

The system then processes a matched claim if it passes the 4 filters even if there is more than one payer on the claim. The payer is identified by the column titled, “Other Coverage Code”. The primary payer is identified by “null”, “0”, or “1”. A secondary payer is identified by a value greater than 1. The system reviews the records submitted and determines if a claim has a primary or secondary payer.

The system creates one invoices per Entity based on interface 15 and sends the invoice either pre-configured FTP location (specific to that entity) or email it to a specified user. An Entity will be charged if the Applicant fee model for the MCO/Entity relationship is Per Match model. The system creates a report on approval, per each MCO, based on interface 14 and FTP's the file to the configured location specific to the MCO. Additionally, the system creates one shared saving statement/invoice based on interface 15/16, per MCO, and transmits the file to the configured location specific to that MCO. The service fee is deducted entirely from the MCO's portion of the shared savings. The system then sends the approval file, either by FTP to an approved location specific to that entity, or by email to a specific user.

The system then archives and deletes data. The system shall retain records successfully imported, but not yet matched, in transaction table for a configurable amount of time in months before archiving. If a claim is submitted after a secondary configured time, based on the date of service the system shall return a flag code of “81” (Record too old.).

Lastly, the system will generate 2 reports, a Claims Status Report and an Admin Data Dump. The Claims Data report is used to determine the status of claims and provides details of the claims submitted by MCO and Entity. Similarly, the Admin Data Dump report is used to review the data currently used in the clearinghouse-matching engine. Salesforce will be used as Admin front end to administer data. Since Salesforce will be used to administer data for Clearinghouse engine, the system shall maintain mechanism to sync data between Salesforce and Clearinghouse. Both reports (Claims Data Report and the Admin Data Dump) should be sortable and should have the ability to export in other formats (PDF, excel, word).

Both Entities and MCO's have their own individual user interface to interact with the system. Entity users and administrators, have the ability to search and view claims as well as shared savings statements. Additionally, Entity users and administrators are provided a means to view MCO based configuration data and allowed some editing ability to authorized users login information. Similarly, MCO users and administrators have the ability to search and view claims as well as shared savings statements. Additionally, MCO users and administrators are provided a means to view MCO based configuration data and allowed some editing ability to authorized users login information.

The exemplary interface of the preferred embodiment includes individual web portals designed for Entities and MCO's, which are comprised of numerous components thereby allowing versatility to the user, permitting the one to search/view both claims and shared savings statements. Equivalent displays or displayable information may further be generated with respect to other equivalent interface platforms within the scope of the present invention. Various additional display screens may be understood as being further generated for the interface of the present invention but are nonetheless omitted in the figures shown, without any implication or understanding to be drawn from such omissions, such displays including for example user login screens, and data entry fields.

The preferred embodiment comprises five key display screens that assist and allow the user to interact seamlessly with the system. The screens on the web portals for both the Entity users and MCO users are: Login, My Account, Invoice Summary, Claims Search, Administrator, and Reports. However, one of skill in art can appreciate many alternative arrangements and configurations that can be constructed to achieve differing technical and stylistic benefits.

Before either an Entity user, MCO user or their respective administers can access the system, they must be granted admittance to enter the web portal via logging-in. Upon the user's initial attempt to access the system, the system prompts the user to Log In, 810, by requesting a username and password. If the username and passwords are approved within the system the user is granted access to the system and is brought to the home screen, 820. However, upon failing to enter the correct log-in information, the user is blocked from accessing the system, 815.

The preferred embodiment for both Entities and MCO's home screen, 820, are comprised of a navigation bar, 825, which contains five tabs the user can review. The five tabs are: My Account, 830, Invoice Summary, 840, Claims Search, 850, Administrator, 860, and Reports, 870. The navigation bar, 825, also contains a prompt which allows the user to Log Out, 890, of the Web Portal, once the user finishes reviewing the desired information.

The first option on the navigation bar, 825, is titled, My Account, 830. My Account, 830, and its sub-selections, are only visible and accessibly by the administrator and are pre-populated with the previously inputted information. The My Account, 830, option within the Entity Web Portal has 2 different selections contained within it, Schedule, 831, and Contacts and Relationships, 832. However, the My Account, 830, option within the MCO's Web Portal has 3 different selections contained within it, Schedule, 831, Fee Structure, 832, and Contacts and Relationships, 833. The Schedule screen, 831, (for both Entity and MCO web portal) allows the administrator to view all relevant information and determine whether or not the certain information is accurate. This screen depicts the FTP locations for incoming information, invoices and shared savings statements, as well as feedback. The information displayed is only related to the actual Entity that is logged in. The My Account tab, 830, also contains information pertaining to Contacts and MCO Relationships, 832. The Contacts and Relationships tab, 832, allows the administrator to view relevant information and determine whether or not the information is accurate. This screen contains all biographical contact information regarding the Entities or MCO's representative. Further the Contacts and Relationships tab, 832, shows all of the MCO relationships that the Entity has and visa-versa, dependent on which party administrator is viewing the Web Portal. The MCO web portal contains an additional selection, Fee Structure, 833, that is not contained within the Entity web portal. The Fee Structure selection, 833, under My Account, 830, allows the administrator to view various fee structures and determine if it is accurate. The Fee Structure selection, 833, is dependent on the relationship between the MCO and State. Further, the Fee Structure, 833, tab provides a default fee structure and entity specific fee structures, which are pre-populated. Additionally, The Fee Structure, 833, selection provides the State cut percentages of all States that the MCO has a relationship with, be it either a negotiated or standard percentage. The Fee Structure, 833, also includes the AWP and WAC that the State uses to determine the cost of prescription average cost.

The next option, within the Entity web portal is titled invoice summary, 840, which allows the user to view the shared savings statement by both its number and month. The user can review a list of all invoice statements which is sortable and includes the invoice number, the date the shared savings was run as well as the shared savings fee, and the State fee. The user can select and review Invoice Details, 841, of any particular invoice by clicking the respective hyperlink button. The details give a complete overview of the services provided and prescription drugs given to a person covered under the 340B program. For example, information that is included in the report includes but is not limited to, the Invoice number, date of service (the date the claim was made), a prescription reference number (the number associated with a specific prescription), fill number (which prescription refill was filled), a prescriber ID (either the DEA or the NPI number of the pharmacy), quantity dispensed, product service ID, total paid (the total paid by the insurance company and the patient co-pay), 340B dispense fee (the fee charged by the pharmacy for dispensing the prescription), 340B plan receipts (reflects what was received for the prescription), BIN (refers to the provider identity), Group ID (contains a number that is used to identify a provider), status of claim (depicts whether the claim has been approved, rejected, pending, invoiced or new), total shared savings (reflects the total shared savings that is split between the MCO and entity), and many more. Each grid of information is sortable by column, and has the ability to be exported to various formats—such as PDF, excel or word.

The next option, within the MCO web portal is titled Shared Savings Statement Summary, 850, which allows user to view the shared savings statement by number and month. The Shared Savings Statements Summary, 850, lists all shared savings statements, its month, its year, the total shared savings, and the state fee. Each grid of information is sortable by column, and has the ability to be exported to various formats. The user is then able to select an individual Shared Savings statement to view the details, 851, of the particular selected statement. For example, information that is included in the Shard Savings statement details includes but is not limited to, the entity (the entity associated with the MCO for this statement), date of service (the date the claim was made), prescription reference number (associated with a specific prescription), fill number (specifies which refill it is), prescriber ID (reflects either the DEA, or NPI number of the pharmacy), quantity dispensed, Product Service ID (reflects the product dispensed), Total paid (reflects the total paid by the insurance company and the patients co-pay), 340B dispense fee (refers to the fee charged by the pharmacy for dispensing the prescription), 340B plan receipts (reflects what was received for the prescription), BIN (refers to the provider identity), Group ID (contains a number that is used to identify a provider), status of claim (depicts whether the claim has been approved, rejected, pending, invoiced or new), total shared savings (reflects the total shared savings that is split between the MCO and entity), and many more. Each grid of information is sortable by column, and has the ability to be exported to various formats—such as PDF, excel or word.

Another option available to the user, both Entity and MCO, on the Navigation Bar, 825, is the Claims Search tab, 860. It allows the user to specify a search criterion to review specific claims in the database for the specific Entity (on the Entity web portal) or MCO (on the MCO web portal) logged-in. The database claims can be filtered based on relationships that the MCO has with the Entities. A user can specify all Entities or a specific Entity. The search can be further filtered by specifying a start and end processing date data; or if the user desires to choose a range they want to search under the Process End Date they type in the latest date the claim was processed. The process start date refers to the latest date that the claim was processed. The final filter allows the user to even further refine his search by describing the status of a claim. The user can select one or more status such as, New, Approved, Pending, Rejected, Invoiced or All. Finally, once the user selected all the specified search criteria and corresponding filters, the web portal will search the database for claims that meet the criteria selected by the user and propagate a Claims Detail, 861, listing all claims that met the user selected criteria. The Claims Details Report, 861, lists all information contained within its databases of each claim that matches the search, it is sortable, and has the ability to be exported in various formats. For example, information that is contained in the Claims Details, 861, includes but is not limited to, date of service (the date the claim was made), prescription reference number (associated with a specific prescription), fill number (specifies which refill it is), prescriber ID (reflects either the DEA, or NPI number of the pharmacy), quantity dispensed, Product Service ID (reflects the product dispensed), Total paid (reflects the total paid by the insurance company and the patients co-pay), 340B dispense fee (refers to the fee charged by the pharmacy for dispensing the prescription), 340B plan receipts (reflects what was received for the prescription), BIN (refers to the provider identity), Group ID (contains a number that is used to identify a provider), status of claim (depicts whether the claim has been approved, rejected, pending, invoiced or new), total shared savings (reflects the total shared savings that is split between the MCO and entity), and many more. The Entities web portal also includes the MCO associated with the entity for the statement; whereas the MCO web portal includes the entity associated with the MCO for this statement.

The Administrator tab, 870, for both the Entity and MCO web portals, allows an administrator to view and edit the Users and send a password reset to a user if necessary. Standard users do not have access to this screen as it is only accessible and editable by administrator log-in. The Administrator tab has two sub categories, User Edit Screen, 871, and User Password Reset screen, 872. The User Edit Screen, 871, contains a list of all approved users including their name, user name, email address, account status and their respective role in their company. Once an administrator is logged-in, the administrator creates new users here and can edit existing users profile information. Similar to the User Edit Screen, 871, the User Password Reset screen, 872, allows an administrator to send an email to a user allowing the user to change their password to access the system.

The Final item in the preferred web portal for both Entities and MCO's is the Reports tab, 880, The Reports tab, 880, gives the user access to four difference reports including, Summary, Detail, Formulary and Rejection. All four reports are available for the user run based on their specific criteria.

The Summary Report gives a summary for the user of critical data of the user's selection. For example, information that is contained in the Summary Report, 880, includes but is not limited to, Entity (user is able to choose from all the Entities the MCO has a relationship with or a single entity), shared savings number (user can select from a list of shared savings numbers with the entity number), From data (date for when the shared savings number was run), to date (user can set the latest date he wants to run a report), null (if not date is specifically chosen, all dates will run in the report), 340B pharmacy payments, 340B dispense fees, 340B pharmacy charges, 340B admin fees, 340B plan receipts, Batch #, inventory order date, 340B pharmacy claims payments, 340B pharmacy dispense fees earned, other pharmacy charges, administration fees, 340B plan receipts due, and many more. Each grid of information is sortable by column, and has the ability to be exported to various formats—such as PDF, excel or word.

The Details Report provides multitude of details for the user regarding various information that the user might be interested in. For example, information that is contained in the Details Report, 880, includes but is not limited to, fill date, RX number, fill number, dispense quantity, total paid, allowance, state percentage, administration fee, MCO shared savings, Entity Shared Savings, and many more. Each grid of information is sortable by column, and has the ability to be exported to various formats—such as PDF, excel or word.

In the preferred embodiment the Formulary Report provides static information regarding the different formularies based on the criteria selected by the user. Preferably, the user can input up to 4 different accounts to run reports against. For example, information that is contained in the Formulary Report, 880, includes but is not limited to, a description, NDC number, generic brand, package units, multiplier packages, total NDC units, and many more. Each grid of information is sortable by column, and has the ability to be exported to various formats—such as PDF, excel or word.

The last report in the preferred embodiment is the Rejection Report. The Rejection Report which shows based on certain user set criteria, all of the rejections based on specific filter classifications. For example, information that is contained in the Rejection Report, 880, includes but is not limited to, ID, Claim date, Invoice ID, number of claims, and many more. Each grid of information is sortable by column, and has the ability to be exported to various formats—such as PDF, excel or word.

As one of skill in art can appreciate, many other alternative arrangements can be constructed to achieve different stylistic benefits according to the teachings of the present invention. Many variations can be imagined as a result of these teachings herein, all of which are intended to be encompassed within the invention as claimed except to the extent anticipated by or made legally obvious by the prior art, or to the extent clearly and unequivocally disclaimed.

Even though the embodiments illustrated and discussed herein represent the most preferred at present, those of ordinary skill in the art will recognize many possible alternatives that have not expressly suggested here. While the foregoing written descriptions enable one of ordinary skill to make and use what is presently considered to be the best modes of the invention, those of ordinary skill will understand and appreciate the existence of variations, combinations, and equivalents of the specific embodiment, method, and examples herein. The drawings and detailed descriptions herein are illustrative, not exhaustive. They do not limit the invention to the particular forms and examples disclosed. To the contrary, the invention includes any further modifications, changes, rearrangements, substitutions, alternatives, design choices, and embodiments apparent to those of ordinary skill in the art, without departing from the spirit and scope of this invention, as defined by any claims included herewith or later added or amended in an application claiming priority to this present filing. The invention covers all embodiments within the scope and spirit of such claims, irrespective of whether such embodiments have been remotely referenced here or whether all features of such embodiments are known at the time of this filing. Thus, the claims should be interpreted to embrace all further modifications, changes, rearrangements, substitutions, alternatives, design choices, and embodiments that may be evident to those of skill in the art. In any case, all substantially equivalent systems, articles, and methods should be considered within the scope of the present invention.

While the present invention is not intended to be exclusively controlled by computer programs or algorithms on the Internet, it is intended that the present invention can be implemented and controlled by computer programs or algorithms over the Internet, or other computer network. Therefore, the present invention contemplates a series of computer algorithms and method by which the present invention is implemented and controlled. Thus, in some of the descriptions herein, the present invention is presented partly in terms of process steps and operations of data bits within a computer memory. An algorithm is here, and generally, conceived to be a self-consistent sequence of steps leading to a desired result. These steps are those requiring physical manipulations of physical quantities. In the present invention, the operations referred to may be automated, machine operations done by a computer or similar device performed in conjunction with a human operator.

The present invention relates to the methods for operating such devices, and processing electrical, magnetic, optic, or other physical signals to generate other desired physical signals. It further relates to a computer program and the control logic contained therein. The present invention also relates to apparatus for performing these operations. The apparatus may be specially constructed for the required purposes or it may comprise a general purpose computer including a non-transitory computer readable medium selectively controlled or reconfigured by a computer program stored in the memory of the computer. Further, because the present invention is intended to include a network of participants, with no geographic limitations, it is contemplated that to better implement the system of the current invention, at least part of such implementation will take place on the Internet, or other computer network. The method presented herein is not inherently related to any particular computer or other apparatus. Similarly, no particular computer programming language is required. The required structure, although not machine specific, will be apparent from the description herein. Additionally, even though a specific device or software application may, or may not, be mentioned in conjunction with a step, or algorithm, or action, it is intended that any appropriate device or software application necessary or capable of implementing that step, or algorithm, or action is anticipated herein. For example, if a step calls for the input of data, it is contemplated that any appropriate devices such as, but not limited to, various input devices, output devices, data storage devices, data transfers devices, could be used and are anticipated herein.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

What is claimed is:

1. A system for managing, processing, and fulfilling pharmaceutical funding claims and supply chains, said system comprising:
a computer system including a processing engine and at least one computer terminal, said at least one computer terminal having at least one communication line, for remote communication through the internet with said processing engine; and
said computer system being programmed to perform a method for managing, processing, and fulfilling pharmaceutical funding claims and supply chains, said method including the steps of:
said computer terminal connecting to said processing engine and transferring over said communication line a claim information file that has been encrypted;
said processing engine decrypting said claim information file and validating said claim information file;
said processing engine importing said validated claim information file into a clearinghouse database;
said processing engine applying, matching and processing algorithms to said clearinghouse database to identify claims with unrealized shared savings;
said processing engine creating invoices for said claims with unrealized shared savings;
said processing engine updating said claim information file;
said processing engine archiving and generating a report reflecting the success or failure of the claims processing.

2. The system as in claim 1 wherein said claims with unrealized shared savings are offline reversal claims.

3. The system as in claim 1 wherein said claims with unrealized shared savings are recreated approved claims with a proper submission clarification code.

4. The system as in claim 1 wherein said communication line of said at least one computer terminal comprises a plurality of communication methods.

5. The system as in claim 1 wherein said processing engine and said computer terminal are run on the same computing device.

6. The system as in claim 1 wherein said processing engine being programmed allows for user interaction.

7. The system as in claim 1 wherein said processing engine being programmed allows for automated interaction.

8. A method for the management of all aspects of processing and fulfilling funded pharmaceutical supply chains said method including the steps of:
a. receiving pharmaceutical claims from a pharmacy service provider;
b. evaluating and matching said pharmaceutical claims to identify previously adjudicated pharmacy claims with unfulfilled funding;
c. altering, changing, or reclassifying said previously adjudicated pharmacy claims through a system, outside of and unrelated to the system used by said pharmacy service provider who adjudicated said previously adjudicated pharmacy claim;
d. creating a reversing claim of said previously adjudicated pharmacy claim and recreating an altered, changed or reclassified original claim of said previously adjudicated pharmacy claim.

9. The method of claim 8 also including the steps of collecting and reporting of accurate quantities of said previously adjudicated pharmacy claims in which 340B priced drugs were used.

10. The method of claim 8 wherein said previously adjudicated pharmacy claims are 340B claims.
